(19) United States
(12) Patent Application Publication
(10) Pub. No.: US 2023/0150497 A1
(43) Pub. Date: May 18, 2023

(54) TRAVELING ROUTE GENERATING DEVICE, AUTOMATED DRIVING CONTROL DEVICE, AND AUTOMATED DRIVING CONTROL SYSTEM

(71) Applicant: Mitsubishi Electric Corporation, Tokyo (JP)

(72) Inventors: Junichi OKADA, Tokyo (JP); Fumiaki KADOYA, Tokyo (JP); Yuki YOSHIDA, Tokyo (JP); Akihiko HIRAOKA, Hyogo (JP); Kazuo HITOSUGI, Tokyo (JP)

(73) Assignee: Mitsubishi Electric Corporation, Tokyo (JP)

(21) Appl. No.: 17/919,672

(22) PCT Filed: Jun. 1, 2020
(86) PCT No.: PCT/JP2020/021531

§ 371 Date: Oct. 18, 2022

(51) Int. Cl. B60W 30/14; B60W 60/00; B60W 40/09; B60W 40/06; G01C 21/34

(52) U.S. Cl. CPC B60W 30/143; B60W 60/001; B60W 40/09; B60W 40/06; G01C 21/3484; B60W 2555/60; B60W 2520/00; B60W 2540/30; B60W 2552/30; B60W 2556/50

(57) ABSTRACT

The present disclosure relates to a traveling route generating device including: a driving information obtaining unit to obtain position information and speed information on a vehicle with a plurality of timings when a driver manually drives the vehicle; a traveling route creating unit to create a traveling route of the vehicle manually driven, using the position information and the speed information obtained by the driving information obtaining unit; a speed limit information obtaining unit to obtain speed limit information on a road through which the vehicle has traveled; and a traveling route modifying unit to modify the speed information on the traveling route based on the speed limit information obtained by the speed limit information obtaining unit to generate a modified traveling route.

### TECHNICAL FIELD

The present disclosure relates to a traveling route generating device which is mounted on a vehicle and generates a traveling route, and an automated driving control device and an automated driving control system each including the traveling route generating device.

### BACKGROUND ART

Recent years have seen proposals on a technology for automated driving of a vehicle, using a receiver that can receive a Global Positioning System (GPS) signal or a quasi-zenith satellite signal, and a high-definition map with lane-level information. For example, Patent Document 1 proposes a method for generating a high-definition map for automated driving and controlling the automated driving, by recording traveling paths through which a vehicle has been manually driven using a satellite positioning system mounted on the vehicle and converting the recorded traveling paths into a target course.

### PRIOR ART DOCUMENT

### Patent Document

Patent Document 1: Japanese Patent No. 6400056

### SUMMARY

### Problem to be Solved by the Invention

According to Patent Document 1, records of traveling positions and traveling speeds when the vehicle has been manually driven are reflected on the target course for automated driving as they are. The driver drives the vehicle in a manner that he/she considers proper, so that the vehicle properly travels in automated mode. However, the manner in which the vehicle has been manually driven is not always proper for the driver. For example, if a vehicle manually driven for generating a target course is run into a traffic jam and has to travel at a speed lower than the speed that the driver originally desires, traveling data generated at the low speed is reflected on the target course. Consequently, when the vehicle travels in automated mode, the vehicle is controlled at the low speed at which the vehicle had traveled in the traffic jam, regardless of the presence or absence of a traffic jam. In another example, if the driver misreads a curvature of a curve in manually driving a vehicle along the curve and drives the vehicle with a large centrifugal force being generated, traveling data generated with the large centrifugal force being generated is reflected on the target course. Consequently, the vehicle will travel in automated mode with the large centrifugal force being generated. Under the conventional technology, if proper traveling records are not obtained in manually driving a vehicle, the problem is that a target course to be reflected on the automated driving becomes improper.

The present disclosure has an object of providing a traveling route generating device that can obtain a more proper traveling route.

### Means to Solve the Problem

A traveling route generating device according to the present disclosure includes: a driving information obtaining unit to obtain position information and speed information on a vehicle with a plurality of timings when a driver manually drives the vehicle; a traveling route creating unit to create a traveling route of the vehicle manually driven, using the position information and the speed information obtained by the driving information obtaining unit; a speed limit information obtaining unit to obtain speed limit information on a road through which the vehicle has traveled; and a traveling route modifying unit to modify the speed information on the traveling route based on the speed limit information obtained by the speed limit information obtaining unit to generate a modified traveling route.

### Effects of the Invention

Since the traveling route generating device according to the present disclosure modifies the speed information on the traveling route when the subject vehicle has been manually driven, based on the speed limit information on roads to generate a modified traveling route, the traveling route generating device can obtain a more proper traveling route.

### BRIEF DESCRIPTION OF DRAWINGS

FIG. 1 is a functional block diagram illustrating a configuration of a traveling route generating device according to Embodiment 1.

FIG. 2 is a flowchart illustrating overall operations of the traveling route generating device according to Embodiment 1.

FIG. 3 illustrates obtainment of driving information.

FIG. 4 illustrates a process of obtaining speed limit information.

FIG. 5 illustrates a table in which elements of a traveling route and the speed limit information are written side by side.

FIG. 6 illustrates a table for describing calculation of estimated speed limit characteristics.

FIG. 7 illustrates a table for describing calculation of a modified traveling route based on the estimated speed limit characteristics.

FIG. 8 illustrates a traveling route from a starting point to a destination and the speed limit information.

FIG. 9 is a functional block diagram illustrating a configuration of a traveling route generating device according to Embodiment 2.

FIG. 10 illustrates a method for obtaining road curvature information.

FIG. 11 illustrates the method for obtaining road curvature information.

FIG. 12 illustrates a table indicating results of determining whether a section is a curved road section, from the driving information.

FIG. 13 is a flowchart for describing the method for obtaining road curvature information.

FIG. 14 illustrates a method for calculating a radius of curvature of a curved road section.

FIG. 15 illustrates the method for calculating a radius of curvature of a curved road section.

FIG. 16 is a flowchart illustrating overall operations of the traveling route generating device according to Embodiment 2.

FIG. 17 schematically illustrates the traveling route from the starting point to the destination.

FIG. 18 illustrates a table in which elements of the traveling route and radiuses of curvature are written side by side.

FIG. 19 illustrates a table for describing calculation of estimated curved road speed characteristics.

FIG. 20 illustrates a table for describing calculation of the modified traveling route based on the estimated curved road speed characteristics.

FIG. 21 is a functional block diagram illustrating a configuration of a traveling route generating device according to Embodiment 3.

FIG. 22 is a flowchart for describing a method for modifying speed information using the speed limit information and the road curvature information.

FIG. 23 is a functional block diagram illustrating a configuration of an automated driving control device according to Embodiment 4.

FIG. 24 illustrates display screens to be displayed on a touch panel operated by the user.

FIG. 25 is a functional block diagram illustrating a configuration of an automated driving control system according to Embodiment 5.

FIG. 26 is a block diagram illustrating a configuration of the automated driving control system according to Embodiment 5 when a plurality of vehicles communicate with a server.

FIG. 27 is a block diagram illustrating a configuration of the automated driving control system according to a modification of Embodiment 5 when a plurality of vehicles communicate with the server.

FIG. 28 illustrates a hardware configuration that implements the traveling route generating devices according to Embodiments 1 to 3.

FIG. 29 illustrates a hardware configuration that implements the traveling route generating devices according to Embodiments 1 to 3.

### DESCRIPTION OF EMBODIMENTS

### Embodiment 1

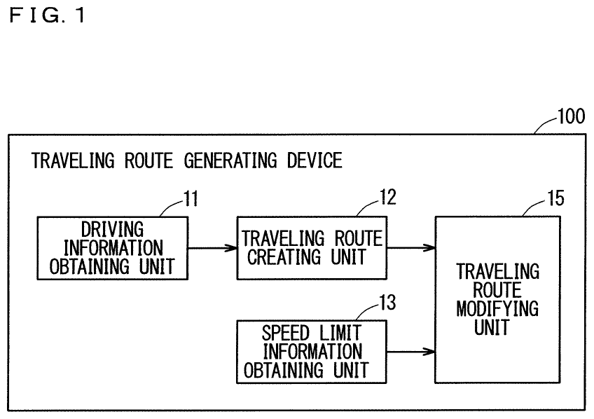

FIG. 1 is a functional block diagram illustrating a configuration of a traveling route generating device 100 according to Embodiment 1. The reference numerals of the constituent elements in FIG. 1 are attached to the same or equivalent elements in other drawings, and the overlapping description will be omitted. A vehicle on which the traveling route generating device 100 is mounted will be hereinafter referred to as a “subject vehicle”.

As illustrated in FIG. 1, the traveling route generating device 100 includes a driving information obtaining unit 11, a traveling route creating unit 12 that receives an output of the driving information obtaining unit 11, a speed limit information obtaining unit 13, and a traveling route modifying unit 15 that receives outputs of the traveling route creating unit 12 and the speed limit information obtaining unit 13.

The driving information obtaining unit 11 obtains position information and speed information on the subject vehicle as driving information. The driving information obtaining unit 11 can obtain the position information through receiving a positioning signal from a satellite positioning system, and obtain the speed information from a speed sensor mounted on the subject vehicle.

The traveling route creating unit 12 creates a traveling route of the subject vehicle, using the driving information obtained by the driving information obtaining unit 11. The traveling route creating unit 12 arranges the pieces of driving information obtained by the driving information obtaining unit 11 in chronological order with the timing of obtaining these to form the traveling route. The traveling route is information corresponding to the position information on positions through which the subject vehicle has traveled and the speed information on speeds of the subject vehicle at the traveling positions.

The speed limit information obtaining unit 13 obtains speed limit information on a road which corresponds to the traveling positions in the driving information obtained by the driving information obtaining unit 11. The speed limit information obtaining unit 13 can obtain the speed limit information from speed limit signs installed along the road, using a forward-looking camera mounted on the subject vehicle.

The traveling route modifying unit 15 modifies the speed information on the traveling route created by the traveling route creating unit 12, based on the speed limit information obtained by the speed limit information obtaining unit 13 on the traveling route through which the subject vehicle has traveled to create a modified traveling route.

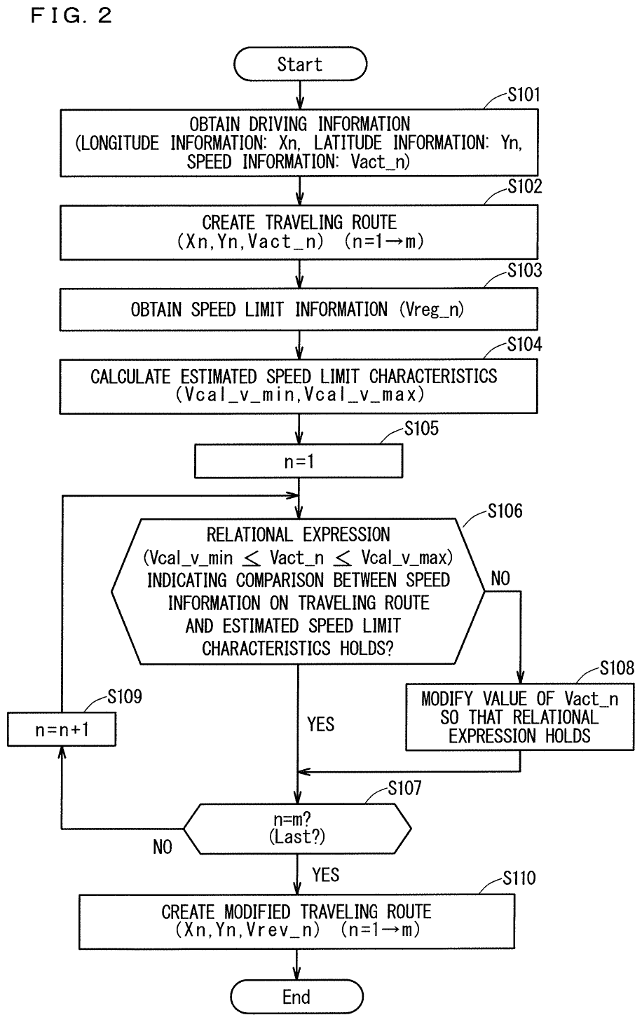

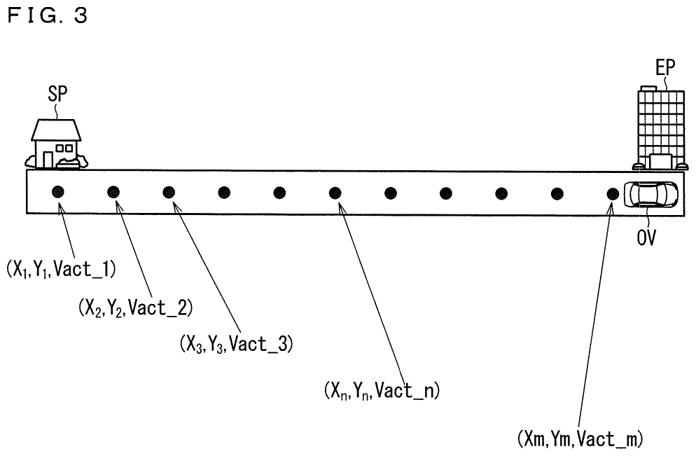

Next, overall operations of the traveling route generating device 100 will be described with reference to a flowchart in FIG. 2. Once the traveling route generating device 100 starts the operations, first, the driving information obtaining unit 11 obtains the driving information (Step S101). The driving information obtaining unit 11 obtains the driving information when the user (driver) manually drives the subject vehicle. This operation will be described with reference to FIG. 3.

Once the subject vehicle OV is manually driven by the user, the driving information obtaining unit 11 obtains the driving information (longitude information: Xn, latitude information: Yn, speed information: Vact_n) of the subject vehicle at regular detection intervals as illustrated in FIG. 3. The driving information obtaining unit 11 obtains this driving information through an entire route from a starting point SP to a destination EP as illustrated in FIG. 3.

The traveling route creating unit 12 generates a traveling route, using the driving information obtained by the driving information obtaining unit 11 (Step S102). The traveling route creating unit 12 arranges the obtained pieces of driving information in chronological order to form the traveling route. Assuming that the order in which the pieces of driving information have been obtained is expressed by n=1, 2, 3, . . . m using n, the traveling route creating unit 12 creates elements (X1, Y1, Vact_1), (X2, Y2, Vact_2), (X3, Y3, Vact_3) . . . (Xm, Ym, Vact_m) for m information detected points from the starting point SP to the destination EP as illustrated in FIG. 3.

When the user manually drives the vehicle, the driving information obtaining unit 11 obtains the driving information, whereas the speed limit information obtaining unit 13 obtains the speed limit information (Step S103). Although the speed limit information obtaining unit 13 obtains the speed limit information after the driving information obtaining unit 11 obtains the driving information in FIG. 2, the speed limit information obtaining unit 13 can obtain the speed limit information simultaneously when the driving information obtaining unit 11 obtains the driving information.

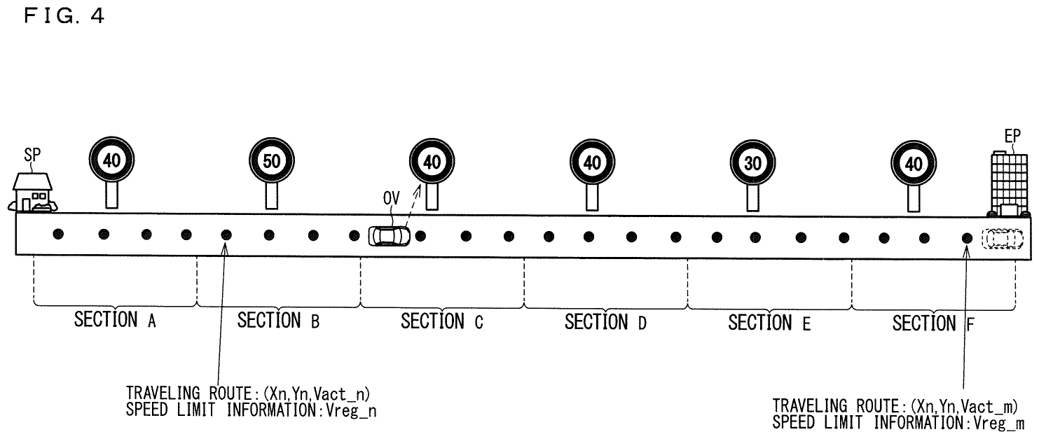

Here, a process of obtaining the speed limit information will be described with reference to FIG. 4. FIG. 4 schematically illustrates an example traveling route generated by the traveling route generating device 100 from the starting point SP to the destination EP. As illustrated in FIG. 3, the traveling route is generated by obtaining a traveling position and a speed of the subject vehicle OV at regular intervals. Besides this obtainment of the traveling route, speed limit signs installed along a road are detected using the forward-looking camera mounted on the subject vehicle. Then, a speed limit value displayed on the detected speed limit sign is obtained as speed limit information Vreg_n. In FIG. 4, the route from the starting point SP to the destination EP is divided into sections A to F, and speed limit information Vreg_n is obtained from the speed limit sign in each of the sections. Then, this speed limit information Vreg_n is associated with elements (Xn, Yn, Vact_n) of the traveling route that have been obtained in the section. Examples of a method for obtaining the speed limit value displayed on the speed limit sign include image processing image data captured by the forward-looking camera and recognizing a displayed value using pattern matching.

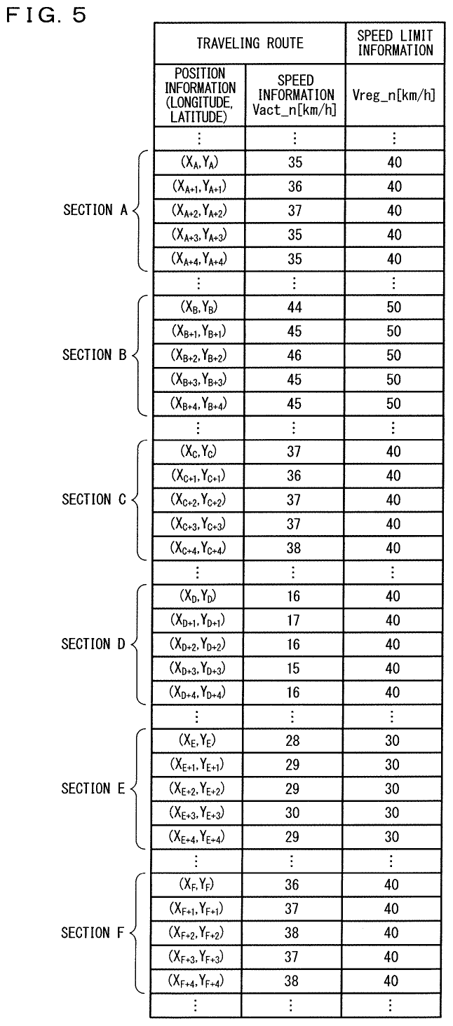

FIG. 5 illustrates an example table in which the elements (Xn, Yn, Vact_n) of the traveling route illustrated in FIG. 4 and the speed limit information Vreg_n are written side by side. FIG. 5 illustrates only an extract from part of information on the sections in the overall information for convenience. FIG. 5 illustrates that the speed limits of the section B and the section E are 50 km/h and 30 km/h, respectively, and the speed limit of each of the other sections is 40 km/h. These speed limits are associated with the elements of the traveling route.

The flowchart of FIG. 2 will be hereinafter described again. After the speed limit information is obtained in Step S103, the traveling route modifying unit 15 calculates estimated speed limit characteristics (Step S104). Here, a process of calculating the estimated speed limit characteristics will be described. The estimated speed limit characteristics are information on driving characteristics indicating at which speed the user drives for the speed limit information on roads. A proper traveling speed will differ depending on the user even on the same road. For example, some users tend to drive at the speed within the speed limit, and some users tend to drive at the speed slightly lower than the speed limit. In Step S104 for calculating the estimated speed limit characteristics, a process of estimating the driving characteristics of the user using a traveling route and the speed limit information is performed.

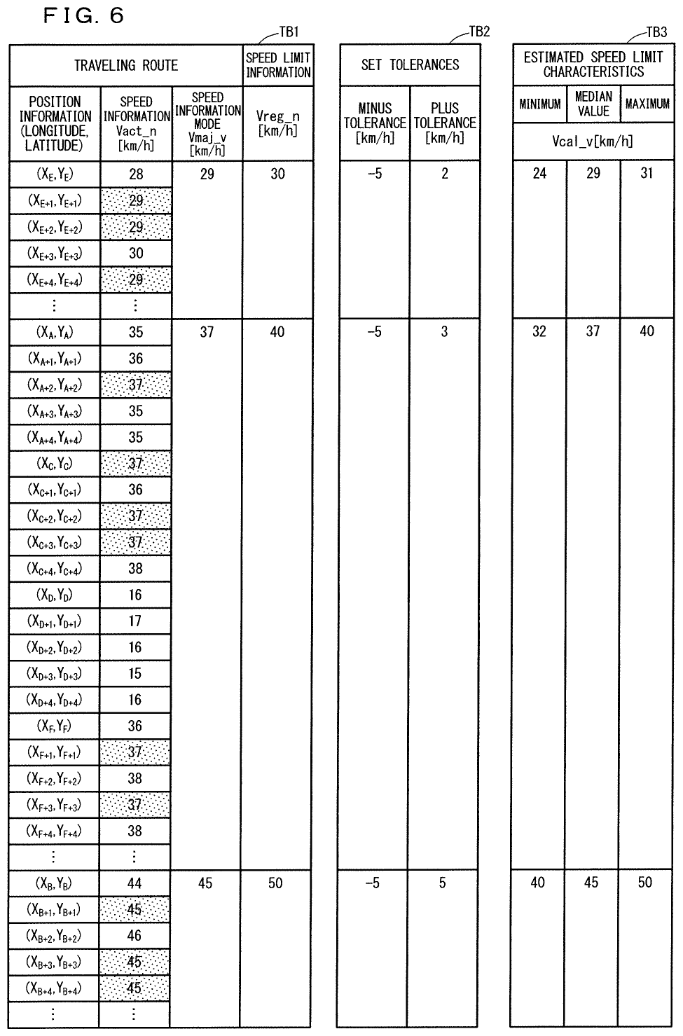

The process of estimating the driving characteristics of the user will be described with reference to FIG. 6. FIG. 6 illustrates tables TB1, TB2, and TB3 in which the elements (Xn, Yn, Vact_n) of the traveling route in the table of FIG. 5 are sorted according to the sections each having the same speed limit information Vreg_n. In FIG. 6, the speed limits are divided into sections with the speed limits of 30 km/h, 40 km/h, and 50 km/h.

In the process of estimating the driving characteristics of the user, first, a speed information mode Vmaj_v that is a speed whose number of elements is the maximum is obtained from the speed information in each of the speed limit sections. As indicated by the table TB1, the number of elements whose traveling speed is 29 km/h in the section whose speed limit is 30 km/h, the number of elements whose traveling speed is 37 km/h in the section whose speed limit is 40 km/h, and the number of elements whose traveling speed is 45 km/h in the section whose speed limit is 50 km/h are the maximum. Each of the traveling speeds becomes the speed information mode Vmaj_v.

Next, tolerances for the speed information mode Vmaj_v in the table TB1 of FIG. 6 are set. As indicated by the table TB2 of FIG. 6, plus and minus values are preset for each piece of the speed limit information. In the example of the table TB2, a minus tolerance of −5 km/h and a plus tolerance of 2 km/h are set in the section whose speed limit is 30 km/h, a minus tolerance of −5 km/h and a plus tolerance of 3 km/h are set in the section whose speed limit is 40 km/h, and a minus tolerance of −5 km/h and a plus tolerance of 5 km/h are set in the section whose speed limit is 50 km/h. The aforementioned sections include the section whose minus tolerance is equal in value to the plus tolerance. Thus, a minus tolerance may be equal in value to a plus tolerance in all the sections.

Next, the estimated speed limit characteristics are obtained using the speed information mode Vmaj_v and the tolerances. Specifically, the estimated speed limit characteristics Vcal_v are obtained by adding the tolerances to the speed information mode Vmaj_v. The table TB3 in FIG. 6 indicates the estimated speed limit characteristics Vcal_v for each of the speed limits. As illustrated in FIG. 6, the estimated speed limit characteristics Vcal_v are speed information (a speed range) with a width of the set tolerances, and have the speed information mode Vmaj_v as its median value. Thus, the estimated speed limit characteristics Vcal_v have the minimum value Vcal_v_min and the maximum value Vcal_v_max. In the example of the table TB3 of FIG. 6, the speed range of the section whose speed limit is 30 km/h is from 24 km/h to 31 km/h, the speed range of the section whose speed limit is 40 km/h is from 32 km/h to 40 km/h, and the speed range of the section whose speed limit is 50 km/h is from 40 km/h to 50 km/h. Each of the speed ranges indicates the estimated speed limit characteristics. These are examples, and the speed information mode is changed according to how the user drives a vehicle. The tolerances are not limited to those in the table TB2. Thus, the estimated speed limit characteristics are not limited to those in the table TB3.

The flowchart of FIG. 2 will be hereinafter described again. After the estimated speed limit characteristics are calculated in Step S104, the traveling route modifying unit 15 performs processes of comparing the speed information on the traveling route with the estimated speed limit characteristics through processes of Steps S105 to S109.

The processes of comparing the speed information on the traveling route with the estimated speed limit characteristics will be described hereinafter. As indicated by Steps S105, S107, and S109, these processes are performed on all the elements from the first element (n=1) to the last element (n=m) in the traveling route.

Specifically, the first element (n=1) of the traveling route is first selected as a target element to be processed (Step S105). Then, whether a relational expression (Vcal_v_min≤Vact_n≤Vcal_v_max) indicating the comparison between the speed information on the traveling route and the estimated speed limit characteristics holds is determined (Step S106).

If the relational expression holds (if YES) in Step S106, the process proceeds to Step S107. If the relational expression does not hold (if NO), the process proceeds to Step S108.

In Step S108, a process of modifying a value of the speed information Vact_n so that the relational expression (Vcal_v_min≤Vact_n≤Vcal_v_max) holds is performed.

In Step S107, whether the processed element is the last element (m) is determined. If the processed element is determined to be the last element (if YES), the process proceeds to Step S110. If the processed element is not the last element (if NO), the next element (n=n+1) is selected as a target element to be processed (Step S109), and the processes following Step S106 are repeated.

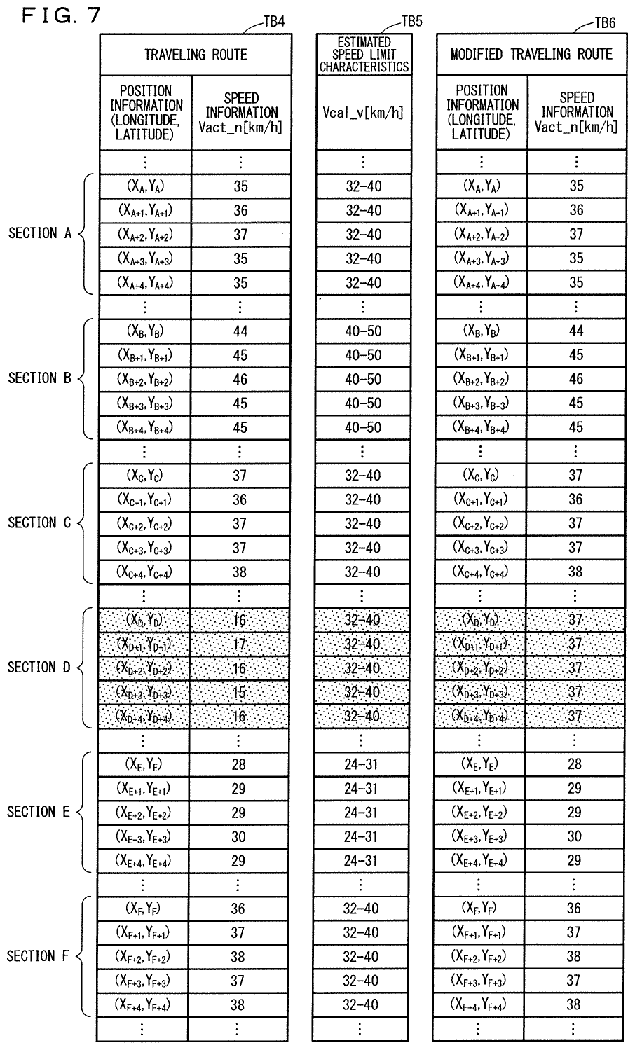

FIG. 7 illustrates altogether a table TB4 on the speed information Vact_n of the subject vehicle for each of the sections in the traveling route which has been extracted in FIG. 5, a table TB5 on the estimated speed limit characteristics Vcal_v for each of the speed limits in FIG. 6, and a table TB6 on the modified traveling route of the subject vehicle for each of the sections.

In the example of FIG. 7, all pieces of the speed information in the sections A, B, C, E, and F satisfy the aforementioned relational expression. Assuming that the traveling route that matches the speed limit characteristics of the user is obtained in these sections, modification of the pieces of the speed information on the traveling route is determined to be unnecessary, and the element n of the traveling route is not modified.

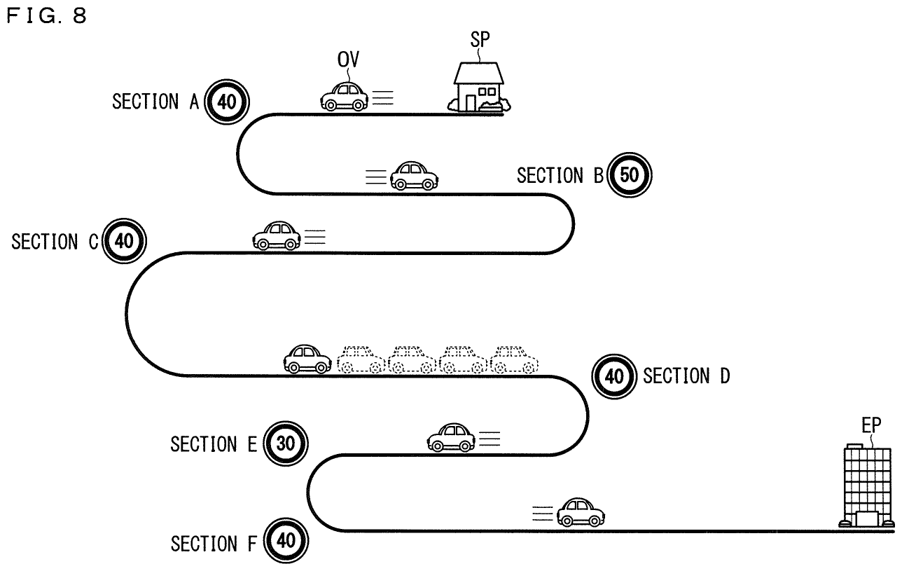

In contrast, the speed information Vact_n on the traveling route in the section D in FIG. 7 falls out of the range of the estimated speed limit characteristics (from Vcal_v_min to Vcal_v_max). One example reason why this occurs will be described with reference to a schematic diagram of FIG. 8. FIG. 8 schematically illustrates an example of generating a traveling route from the starting point SP to the destination EP using the traveling route generating device 100. FIG. 8 illustrates a case where no traffic jam occurs while the subject vehicle OV travels through the sections A, B, and C but the subject vehicle OV is forced to decelerate in the section D due to a traffic jam with respect to an original proper speed of the user. Thus, an incident where the relational expression (Vcal_v_min≤Vact_n≤Vcal_v_max) is not satisfied in the section D occurs.

Assuming that the traveling route that matches the speed limit characteristics of the user is not obtained in this section, the speed information Vact_n is automatically modified (Step S108). In this process, the value of Vact_n may be any value as long as the relational expression is satisfied.

In the example of FIG. 7, the speed information Vact_n is modified into 37 km/h that is the median value of the estimated speed limit characteristics in the section whose speed limit is 40 km/h in FIG. 6.

The flowchart of FIG. 2 will be hereinafter described again. Upon completion of the processes S106 to S109 on all the elements (from n=1 to m) in the traveling route, the process proceeds to Step S110. Assuming that the speed information created in the process of Step S110 is final speed information Vrev_n, the traveling route created by this final speed information Vrev_n and the position information is defined as a modified traveling route (Xn, Yn, Vrev_n). The traveling route modifying unit 15 outputs the modified traveling route (Xn, Yn, Vrev_n) outside the traveling route generating device 100. This modified traveling route is used during the automated driving of the subject vehicle from the starting point SP to the destination EP.

As described above, the traveling route generating device 100 according to Embodiment 1 can estimate characteristics of the user toward the speed limit, automatically modify the speed information on a traveling route into a proper traveling speed that matches the characteristics of the user, and obtain a more proper traveling route, without reflecting the speed information in the driving information obtained during manual driving of the subject vehicle on a traveling route of automated driving as it is. Thus, even in the presence of a section where the user cannot properly drive due to, for example, a traffic situation while manually driving the subject vehicle to obtain the driving information, the traveling route generating device 100 automatically modifies the speed of the section into a proper traveling speed. This saves the user from manually driving the subject vehicle again for obtaining the proper driving information, and can reduce the inconvenience of performing operations of creating a traveling route.

Although the example above describes the installment of the traveling route generating device 100 on a vehicle, the traveling route generating device 100 may be installed in a base station except for the vehicle, for example, a server, obtain driving information and speed limit information from the vehicle through a communication network, and create and modify a traveling route in the server. The server has only to transmit the created and modified traveling route to the vehicle through the communication network.

A method for the speed limit information obtaining unit 13 to obtain speed limits may be obtaining speed limit information on a road through which the subject vehicle has traveled from map information of a car navigation apparatus mounted on the subject vehicle, instead of detecting speed limit signs installed along the road, using a forward-looking camera.

Although the estimated speed limit characteristics are calculated using the elements of the traveling route in Embodiment 1, the estimated speed limit characteristics may be calculated using driving information obtained except when the traveling route is created.

Furthermore, a fixed setting value may be used as a value of the speed limit information in calculating the maximum value Vcal_v_max of the estimated speed limit characteristics, instead of calculating the maximum value Vcal_v_max based on a speed information mode and its tolerances. Even when the subject vehicle travels at a speed over the speed limit in obtaining the driving information, the subject vehicle can travel in automated mode always within a speed limit range because the speed information in a modified traveling route is set lower than or equal to the speed of the maximum value Vcal_v_max.

### Embodiment 2

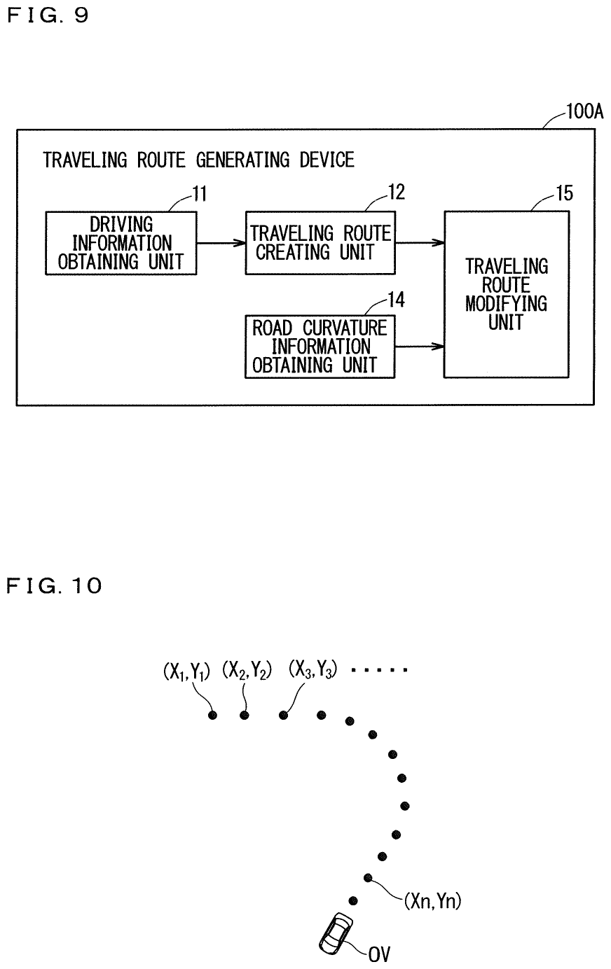

FIG. 9 is a functional block diagram illustrating a configuration of a traveling route generating device 100A according to Embodiment 2. As illustrated in FIG. 9, the traveling route generating device 100A includes a road curvature information obtaining unit 14, instead of the speed limit information obtaining unit 13 of the traveling route generating device 100 according to Embodiment 1.

The road curvature information obtaining unit 14 obtains road curvature information on a road from traveling positions in the driving information obtained by the driving information obtaining unit 11, and outputs the road curvature information to the traveling route modifying unit 15.

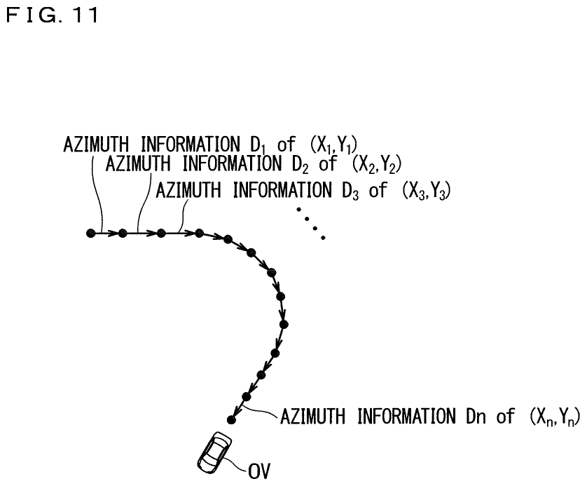

A method for obtaining the road curvature information will be described with reference to FIGS. 10 to 15. FIG. 10 illustrates position information (Xn, Yn) of a plurality of elements of driving information obtained by the subject vehicle OV in a curved road section. FIG. 11 schematically illustrates azimuth information Dn calculated for each of the obtained elements of the driving information, using a vector. The driving information in Embodiment 2 includes position information (a longitude and a latitude), and the azimuth information (deg).

A method for obtaining the azimuth information is forming a vector connecting the position information (Xn, Yn) of each of the elements of driving information to another preceding element, and obtaining an orientation of the vector as the azimuth information Dn as illustrated in FIG. 11. The azimuth information Dn is a value of an angle. A specific value can be obtained by defining, for example, the north as 0 degree and a clockwise direction as a positive direction. Then, an azimuth difference (Dn)−(Dn−1) between the azimuth information Dn of a target element and azimuth information Dn−1 of an immediate preceding element, that is, an element immediate past with respect to the target element when detected among elements arranged in chronological order is calculated. If a value of the calculated azimuth difference is a value higher than or equal to a preset threshold, the road is determined to be a curved road. In the example of FIG. 11, the vector connects the target element to one further element. As long as the element to be connected to the vector is an element ahead the target element, the element need not be the one further element.

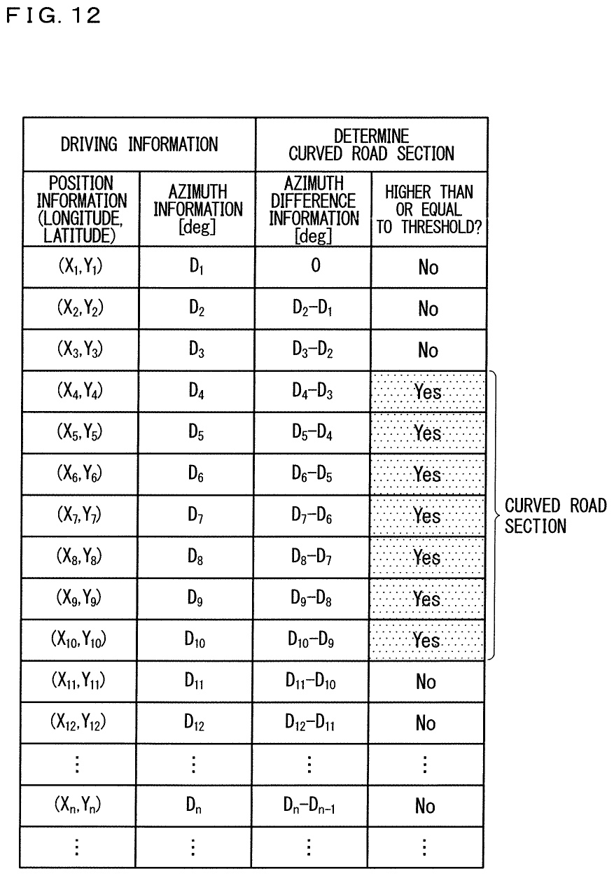

FIG. 12 illustrates a table indicating results of determining whether a section is a curved road section, from the driving information. First, pieces of azimuth difference information corresponding to all the elements are calculated. The first information detected point at which the azimuth difference (Dn)−(Dn−1) is higher than or equal to a threshold is determined to be a start point of a curved road section, whereas the last information detected point at which the azimuth difference (Dn)−(Dn−1) is higher than or equal to the threshold is determined to be an end point of the curved road section. In the example of FIG. 12, values of the azimuth differences at the information detected points from position information (X4, Y4) to (X10, Y10) among the information detected points from position information (X1, Y1) to position information (Xn, Yn) are higher than or equal to the threshold (Yes), and the section is determined to be a curved road section. The values of the azimuth differences at the other information detected points are lower than the threshold (No), and the sections are determined to be straight road sections.

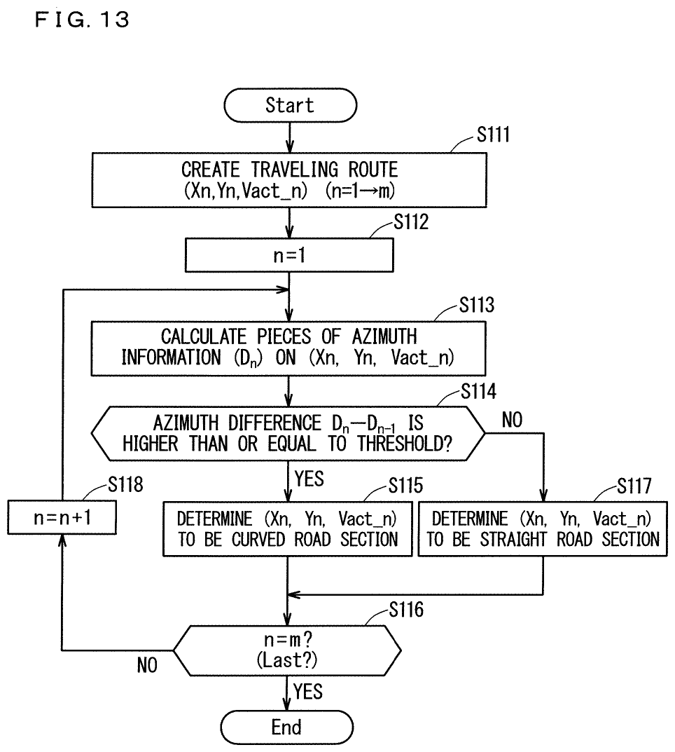

FIG. 13 is a flowchart for describing a method for calculating a curved road section as described above. As described using the flowchart in FIG. 2, the traveling route creating unit 12 generates a traveling route, using the driving information (longitude information: Xn, latitude information: Yn, speed information: Vact_n) obtained by the driving information obtaining unit 11 (Step S111).

Then, the traveling route creating unit 12 selects the first element (n=1) of the traveling route as a target element to be processed (Step S112), and calculates pieces of azimuth information (Dn) on elements of the driving information (Step S113). Since the first element of the traveling route has no preceding element, the azimuth information is 0 degree.

Next, the azimuth difference (Dn)−(Dn−1) between the azimuth information Dn and the azimuth information Dn−1 of the element immediate past with respect to the target element when detected is calculated, and whether the azimuth difference is higher than or equal to a predefined threshold is determined (Step S114). If the azimuth difference is higher than or equal to the threshold (if YES), the process proceeds to Step S115. It is determined in Step S115 that the information detected points of the driving information (longitude information: Xn, latitude information: Yn, speed information: Vact_n) are in a curved road section. Then, the process proceeds to Step S116. If the azimuth difference is lower than the threshold (if NO), the process proceeds to Step S117. It is determined in Step S11 that the information detected points are in a straight road section. Then, the process proceeds to Step S116. Since the azimuth information on the first element of the traveling route is 0 degree, the point is determined to be in a straight road section.

In Step S116, whether the processed element is the last element (m) is determined. If the processed element is determined to be the last element (if YES), a process of calculating a curved road section is ended. If the processed element is not the last element (if NO), the next element (n=n+1) is selected as a target element to be processed (Step S118), and the processes following Step S113 are repeated.

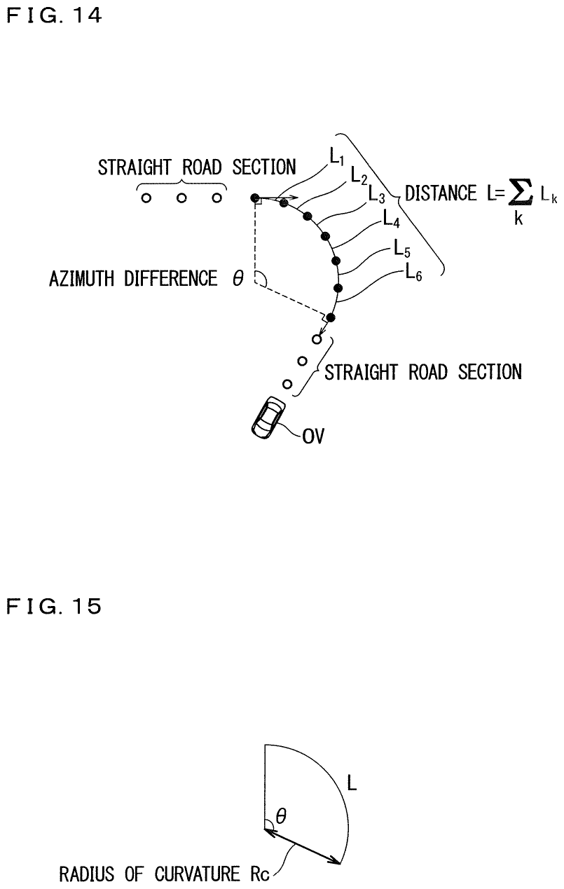

Next, a method for calculating a radius of curvature of a curved road section will be described with reference to FIGS. 14 and 15. FIG. 14 schematically illustrates a method for calculating a distance L from a starting point to an end point of a curved road section which corresponds to the position information (X4, Y4) to (X10, Y10). Each of L1 to L6 denotes a distance Lk between information detected points in a preceding-following position relationship, among information detected points from the starting point to the end point of the curved road section. FIG. 14 also illustrates an azimuth difference A obtained from azimuths of the starting point and the end point of the curved road section.

The distance L from the starting point to the end point of the curved road section is calculated by summing the distances L1 to L6. As illustrated in FIG. 15, a sector is formed by the distance L and the azimuth difference θ. Then, a radius of the sector which is calculated by L/θ is determined as a radius of curvature Rc. As described above, elements of a curved road section in a traveling route are extracted from the pieces of position information on the traveling route. Then, curvature information on the curved road section is calculated.

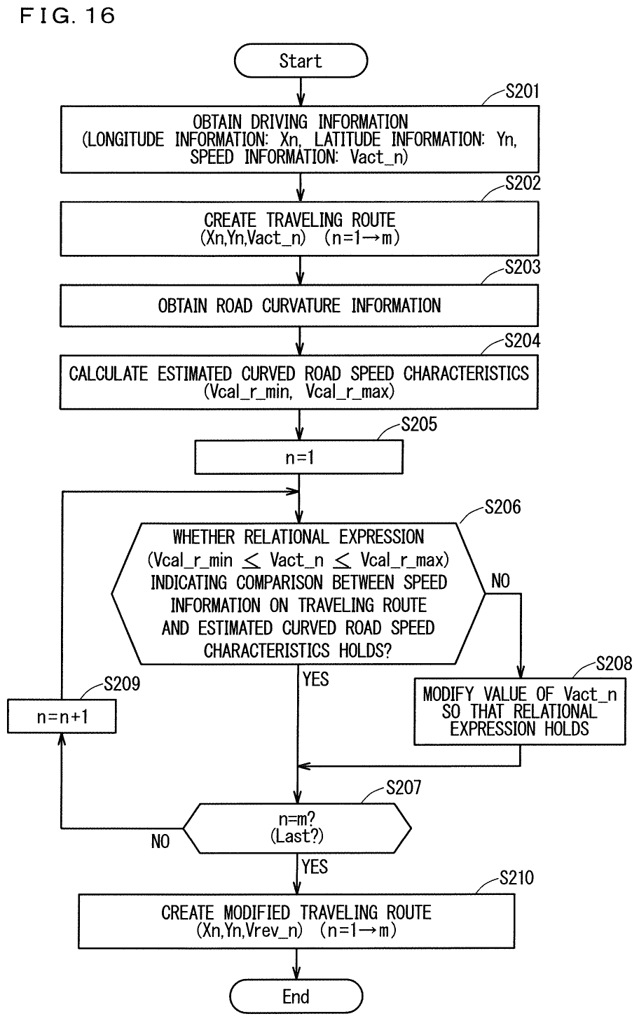

Next, overall operations of the traveling route generating device 100A will be described with reference to a flowchart illustrated in FIG. 16. Since the processes in Steps S201 and S202 are identical to those in Steps S101 and S102 in FIG. 2, the description will be omitted.

When the user manually drives the vehicle, the driving information obtaining unit 11 obtains the driving information, whereas the road curvature information obtaining unit 14 obtains the road curvature information (Step S203).

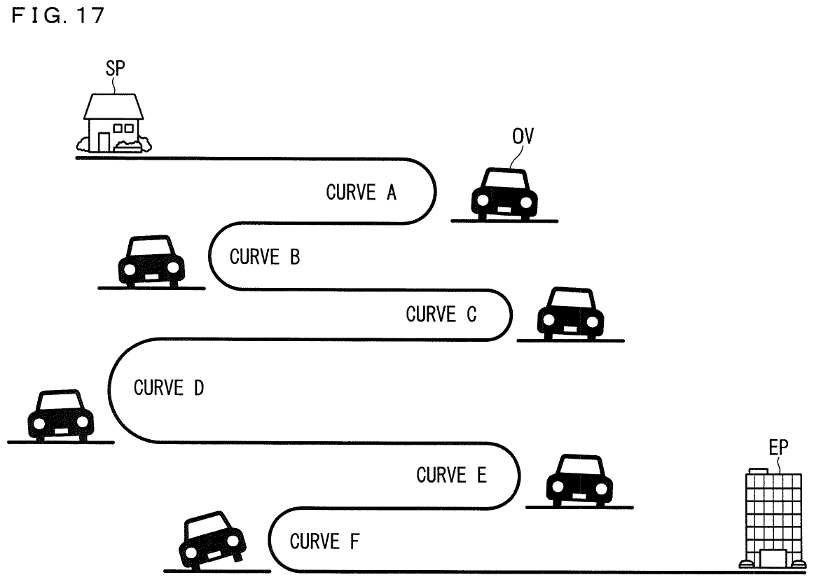

Here, a process of obtaining the road curvature information will be described with reference to FIG. 17. FIG. 17 schematically illustrates an example of generating a traveling route from the starting point SP to the destination EP using the traveling route generating device 100A. In the example of FIG. 17, the traveling route includes curved roads from a curved road section A to a curved road section F. FIG. 17 schematically illustrates subject vehicles next to the curved roads.

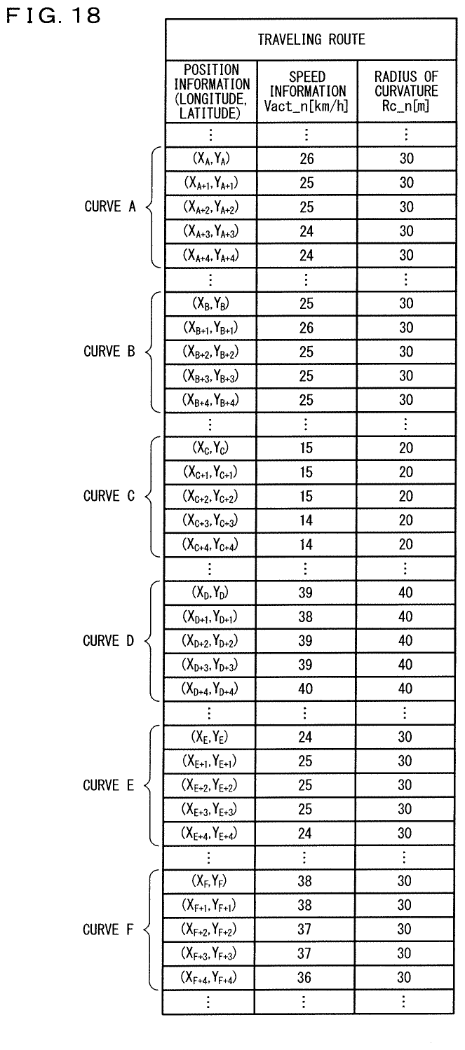

FIG. 18 illustrates an example table in which elements of each curved road section in a traveling route (position information (a longitude and a latitude), speed information (Vact_n)), and values of radiuses of curvature Rc n are written side by side. FIG. 18 omits elements of straight road sections. FIG. 18 illustrates that radiuses of curvature of a curved road section C and a curved road section D are 20 m and 40 m, respectively, and a radius of curvature of the other curved road sections is 30 m. These radiuses of curvature are associated with the elements of the traveling route.

The flowchart of FIG. 16 will be hereinafter described again. After the road curvature information is obtained in Step S203, the traveling route modifying unit 15 calculates estimated curved road speed characteristics (Step S204). Here, a process of calculating the estimated curved road speed characteristics will be described. The estimated curved road speed characteristics are information on driving characteristics indicating at which speed the user drives according to a curvature of a curve. Basically, smaller a radius of curvature of a curved road is, at a lower speed the user drives. However, the optimal traveling speed differs depending on the user, even in curved roads with the same curvature. Such characteristics different for each user are calculated using the driving information in manually driving a vehicle.

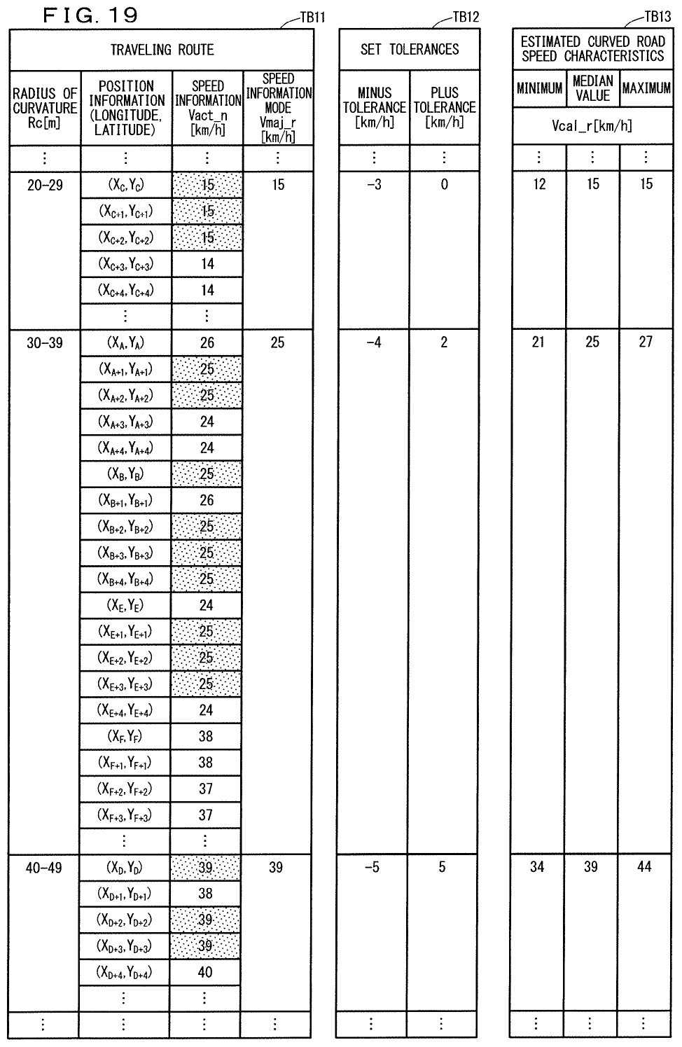

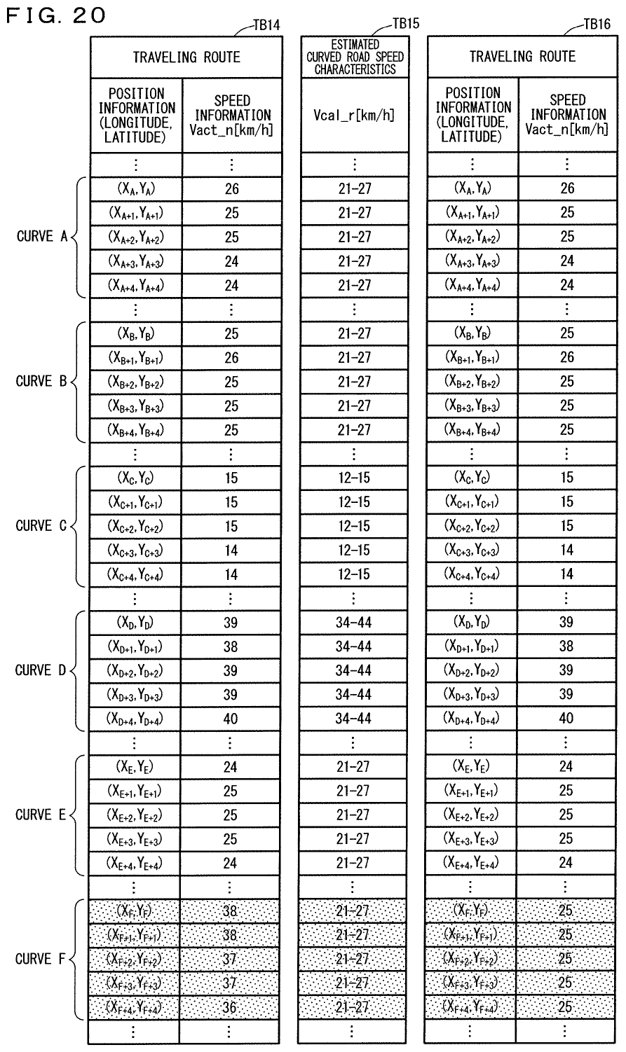

The process of estimating the driving characteristics of the user will be described with reference to FIG. 19. FIG. 19 illustrates tables TB11, TB12, and TB13 in which the elements (Xn, Yn, Vact_n) of the traveling route in the table of FIG. 18 are sorted according to the radiuses of curvature Re. In the example of FIG. 19, the speed information Vact_n is classified by sorting the radiuses of curvature Rc per 10 m, i.e., from 20 to 29 m, from 30 to 39 m, and from 40 to 49 m.

In the process of estimating the driving characteristics of the user, first, a speed information mode Vmaj_r that is a speed whose number of elements is the maximum is obtained from the speed information in each of the radiuses of curvature. As illustrated in the table TB11, the number of elements of the traveling speed of 15 km/h in the section whose radius of curvature ranges from 20 to 29 m, the number of elements of the traveling speed of 25 km/h in the section whose radius of curvature ranges from 30 to 39 m, and the number of elements of the traveling speed of 39 km/h in the section whose radius of curvature ranges from 40 to 49 m are the maximum. Thus, each of the traveling speeds becomes the speed information mode Vmaj_r.

Next, tolerances for the speed information mode Vmaj_r in the table TB11 of FIG. 19 are set. As indicated by the table TB12 of FIG. 19, plus and minus values are preset for each piece of the speed limit information. In the example of the table TB12, a minus tolerance of −3 km/h and a plus tolerance of 0 km/h are set in the section whose radius of curvature ranges from 20 to 29 m, a minus tolerance of −4 km/h and a plus tolerance of 2 km/h are set in the section whose radius of curvature ranges from 30 to 39 m, and a minus tolerance of −5 km/h and a plus tolerance of 5 km/h are set in the section whose radius of curvature ranges from 40 to 49 m. Although the aforementioned sections include the section whose minus tolerance is equal in value to the plus tolerance, a minus tolerance may be different in value to a plus tolerance in all the sections.

Next, the estimated curved road speed characteristics are obtained using the speed information mode Vmaj_r and its tolerances. Specifically, the estimated speed limit characteristics Vcal_r are obtained by adding the tolerances to the speed information mode Vmaj_r. The table TB13 in FIG. 19 indicates the estimated curved road speed characteristics Vcal_r for each of the radiuses of curvature. As illustrated in FIG. 19, the estimated curved road speed characteristics Vcal_r are speed information (a speed range) with a width of the set tolerances, and have the speed information mode Vmaj_r as its median value. Thus, the estimated curved road speed characteristics Vcal_r have the minimum value Vcal_r_min and the maximum value Vcal_r_max. In the example of the table TB13 in FIG. 19, the speed ranges are from 12 km/h to 15 km/h in the section whose radius of curvature ranges from 20 to 29 m, from 21 km/h to 27 km/h in the section whose radius of curvature ranges from 30 to 39 m, and from 34 km/h to 44 km/h in the section whose radius of curvature ranges from 40 to 49 m. These speed ranges represent the estimated curved road speed characteristics. These are examples, and the speed information mode is changed according to how the user drives a vehicle. The tolerances are not limited to those in the table TB12. Thus, the estimated curved road speed characteristics are not limited to those in the table TB13.

The flowchart of FIG. 16 will be hereinafter described again. After the estimated curved road speed characteristics are calculated in Step S204, the traveling route modifying unit 15 performs processes of comparing the speed information on the traveling route with the estimated curved road speed characteristics through processes of Steps S205 to S209.

The processes of comparing the speed information on the traveling route with the estimated curved road speed characteristics will be described hereinafter. As indicated by Steps S205, S207, and S209, these processes are performed on all the elements from the first element (n=1) to the last element (n=m) in the traveling route.

Specifically, the first element (n=1) of the traveling route is first selected as a target element to be processed (Step S205). Then, whether a relational expression (Vcal_r_min≤Vact_n≤Vcal_r_max) indicating the comparison between the speed information on the traveling route and the estimated curved road speed characteristics holds is determined (Step S206).

If the relational expression holds (if YES) in Step S206, the process proceeds to Step S207. If the relational expression does not hold (if NO), the process proceeds to Step S208.

In Step S208, a process of modifying a value of the speed information Vact_n so that the relational expression (Vcal_r_min≤Vact_n≤Vcal_r_max) holds is performed.

In Step S207, whether the processed element is the last element (m) is determined. If the processed element is determined to be the last element (if YES), the process proceeds to Step S210. If the processed element is not the last element (if NO), the next element (n=n+1) is selected as a target element to be processed (Step S209), and the processes following Step S206 are repeated.

FIG. 20 illustrates altogether a table TB14 on the speed information Vact_n of the subject vehicle for each of the sections in the traveling route which has been extracted in FIG. 18, a table TB15 on the estimated curved road speed characteristics Vcal_r for each of the speed limits in FIG. 19, and a table TB16 on the modified traveling route of the subject vehicle for each of the sections.

In the example of FIG. 20, all pieces of the speed information in the curved road sections A to E satisfy the aforementioned relational expression. Assuming that the traveling route that matches the curved road speed characteristics of the user is obtained in these sections, modification of the speed information on the traveling route is determined to be unnecessary, and the element n of the traveling route is not modified.

In contrast, the speed information Vact_n on the traveling route in the curved road section F in FIG. 20 falls out of the range of the estimated curved road speed characteristics (from Vcal_r_min to Vcal_r_max). The conceivable reason why this occurs is that the user misreads a curvature of a curved road and enters the curve at a speed higher than the traveling speed that the user originally considers optimal, for example, as schematically illustrated in FIG. 17. Thus, an incident where the relational expression (Vcal_rmin≤Vact_n≤Vcal_r_max) is not satisfied occurs.

Assuming that the traveling route that matches the curved road speed characteristics of the user is not obtained in this curved road section, the speed information Vact_n is automatically modified (Step S208). In this process, the value Vact_n may be any value as long as the relational expression is satisfied.

In the example of FIG. 20, the speed information Vact_n is modified into 25 km/h that is the median value of the estimated curved road speed characteristics in the section whose radius of curvature ranges from 30 to 39 m in FIG. 19.

The flowchart of FIG. 16 will be hereinafter described again. Upon completion of the processes S206 to S209 on all the elements (from n 1 to m) in the traveling route, the process proceeds to Step S210. Assuming that the speed information created in the process of Step S210 is final speed information Vrev_n, the traveling route created by this final speed information Vrev_n and the position information is defined as a modified traveling route (Xn, Yn, Vrev_n). The traveling route modifying unit 15 outputs the modified traveling route (Xn, Yn, Vrev_n) outside the traveling route generating device 100A. This modified traveling route is used during the automated driving of the subject vehicle from the starting point SP to the destination EP.

As described above, the traveling route generating device 100A according to Embodiment 2 can estimate characteristics of the user toward curved roads, automatically modify the speed information on the traveling route into a proper traveling speed that matches the characteristics of the user, and obtain a more proper traveling route, without reflecting the speed information in the driving information obtained during manual driving of the subject vehicle on a traveling route of automated driving as it is. Thus, even in the presence of a section where the user misreads a curvature of a curved road and cannot properly drive while manually driving the subject vehicle to obtain the driving information, the traveling route generating device 100A automatically modifies the speed of the section into a proper traveling speed. This saves the user from manually driving the subject vehicle again for obtaining the proper driving information, and can reduce the inconvenience of performing operations of creating a traveling route.

Although the example above describes the installment of the traveling route generating device 100A on a vehicle, the traveling route generating device 100A may be installed in a base station except for the vehicle, for example, a server, obtain driving information from the vehicle through a communication network, and create and modify a traveling route in the server. The server has only to transmit the created and modified traveling route to the vehicle through the communication network.

A method for the road curvature information obtaining unit 14 to obtain the curvature information may be obtaining the curvature information on a curve of a road through which the subject vehicle has traveled from map information of a car navigation apparatus mounted on the subject vehicle, instead of obtaining the curvature information on the road from the traveling positions in the driving information obtained by the driving information obtaining unit 11. The curvature information may be calculated using the driving information other than that when the traveling route is created.

The maximum value Rc_max of a radius of curvature is set to calculate the estimated curved road speed characteristics. A section in which a radius of curvature of a traveling route is larger than or equal to Rc_max may be determined to be a straight road. Modifying the speed information on the traveling route in a section determined to be a straight road, using the traveling route speed maximum value Vmax instead of using a value of the estimated curved road speed characteristics can limit the speed information on the traveling route.

### Embodiment 3

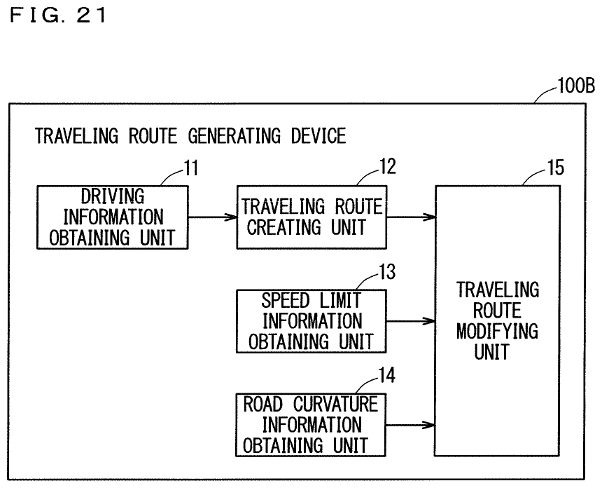

FIG. 21 is a functional block diagram illustrating a configuration of a traveling route generating device 100B according to Embodiment 3. As illustrated in FIG. 21, the traveling route generating device 100B includes the speed limit information obtaining unit 13 of the traveling route generating device 100 according to Embodiment 1, and the road curvature information obtaining unit 14 of the traveling route generating device 100A according to Embodiment 2.

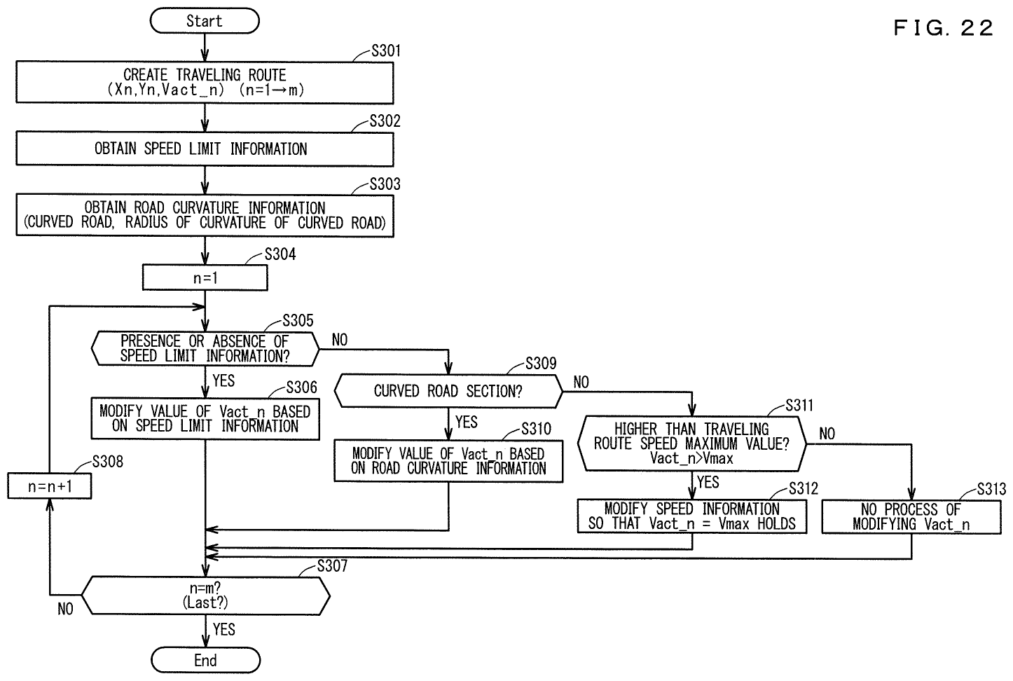

Since Embodiments 1 and 2 describe the method for obtaining the speed limit information by the speed limit information obtaining unit 13 and the method for obtaining the road curvature information by the road curvature information obtaining unit 14, the description will be omitted. Hereinafter, a method for modifying the speed information using the speed limit information and the road curvature information will be described with reference to a flowchart in FIG. 22.

First, the traveling route creating unit 12 generates a traveling route, using the driving information (longitude information: Xn, latitude information: Yn, speed information: Vact_n) obtained by the driving information obtaining unit 11 (Step S301).

Then, the speed limit information obtaining unit 13 obtains the speed limit information (Step S302). The road curvature information obtaining unit 14 obtains the road curvature information (Step S303). This road curvature information may include information on straight roads.

Then, the traveling route creating unit 12 selects the first element (n==1) of the traveling route as a target element to be processed (Step S304), and determines the presence or absence of speed limit information (Step S305).

If the traveling route creating unit 12 determines the presence of the speed limit information (if YES), the process proceeds to Step S306. If the traveling route creating unit 12 determines the absence of the speed limit information (if NO), the process proceeds to Step S309.

In Step S306, the speed information Vact_n is modified based on the speed limit information. Then, the process proceeds to Step S307. Step S306 is a process performed by the traveling route modifying unit 15, and corresponds to the processes in Steps S106 and S108 according to Embodiment 1 in FIG. 2.

In Step S309, whether a section is a curved road section is determined. If the section is determined to be a curved road section (if YES), the process proceeds to Step S310. If the section is not determined to be a curved road section (if NO), the process proceeds to Step S311.

The road curvature information obtained in Step S303 includes information on a radius of curvature. If so, the section can be determined to be a curved road section.

In Step S310, the speed information Vact_n is modified based on the road curvature information. Then, the process proceeds to Step S307. Step S310 is a process performed by the traveling route modifying unit 15, and corresponds to the processes in Steps S206 and S208 according to Embodiment 2 in FIG. 16. The estimated curved road speed to be used for modifying the speed information Vact_n is the one corresponding to the radius of curvature calculated in each of the curved road sections.

Step S311 is a process in the absence of the speed limit information and the road curvature information. Here, whether the speed information Vact_n is higher than the preset traveling route speed maximum value Vmax (Vact_n>Vmax) is determined. If Vact_n>Vmax is determined (if YES), the process proceeds to Step S312. Otherwise (if NO), the process proceeds to Step S313.

In Step S312, the speed information on the traveling route is modified so that the speed information Vact_n is equal to the traveling route speed maximum value Vmax (Vact_n=Vmax). Then, the process proceeds to Step S307.

Step S313 is a process in the absence of the speed limit information and the road curvature information, and a process when the speed information Vact_n does not exceed the traveling route speed maximum value Vmax. The process of modifying the speed information Vact_n is not performed, and the process proceeds to Step S307.

In Step S307, whether the processed element is the last element (m) is determined. If the processed element is determined to be the last element (if YES), a series of the processes is ended. If the processed element is not the last element (if NO), the next element (n=n+1) is selected as a target element to be processed (Step S308), and the processes following Step S305 are repeated.

As described above, the traveling route generating device 100B according to Embodiment 3 can modify the speed information based on the estimated speed limit characteristics in a section where the speed limit information can be obtained. The traveling route generating device 100B can modify the speed information based on the estimated curved road speed characteristics, when the elements of the traveling route do not include the speed limit information but include the road curvature information, that is, when the road is determined to be a curved road. When the elements of the traveling route include neither the speed limit information nor the road curvature information, the traveling route generating device 100B can modify the speed information using the traveling route speed maximum value Vmax.

### Embodiment 4

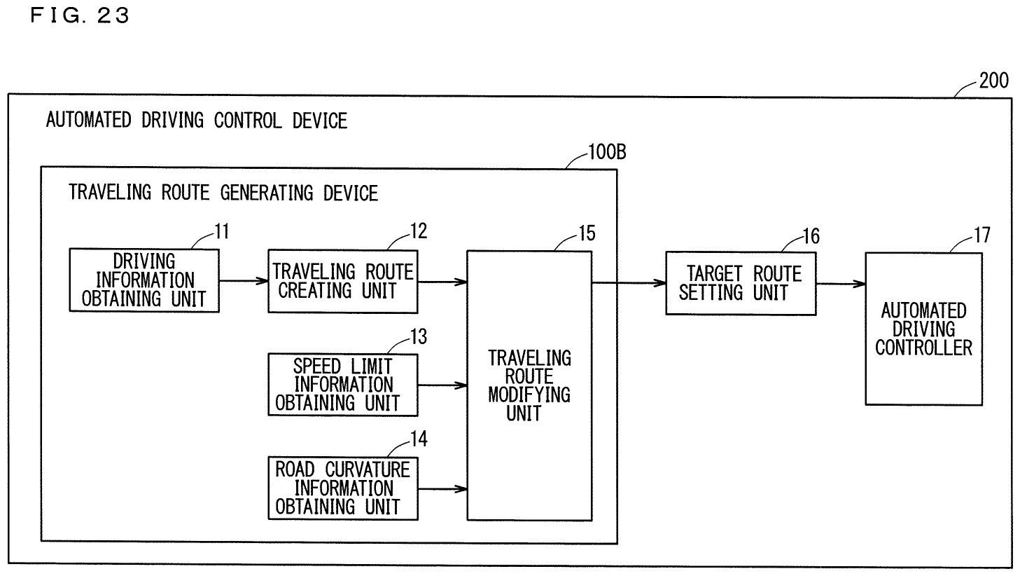

FIG. 23 is a functional block diagram illustrating a configuration of an automated driving control device 200 according to Embodiment 4. As illustrated in FIG. 23, the automated driving control device 200 includes, for example, the traveling route generating device 100B according to Embodiment 3 in FIG. 21, and a target route setting unit 16 and an automated driving controller 17 that are disposed outside the traveling route generating device 100B.

The automated driving control device 200 may include the traveling route generating device 100 according to Embodiment 1 in FIG. 1 or the traveling route generating device 100A according to Embodiment 2 in FIG. 9, instead of the traveling route generating device 100B.

The target route setting unit 16 receives the modified traveling route created by the traveling route modifying unit 15, and sets the modified traveling route as a target route for automated driving of the subject vehicle. The target route setting unit 16 stores a plurality of modified traveling routes created by the traveling route generating device 100B, and sets a target route to be used in response to an external request.

The automated driving controller 17 controls automated driving by properly controlling a steering mechanism and a driving mechanism included in the subject vehicle, according to the position information and the speed information on the target route set by the target route setting unit 16.

A method for setting a target route is disposing, outside the automated driving control device 200, an operating apparatus that the user can operate so that the user can select, with a user operation, a route through which the user desires to drive the subject vehicle in automated mode. Here, each of the modified traveling routes should be set by a name that the user can easily identify, for example, “HOME TO OFFICE” or “HOME TO SUPERMARKET”.

After the target route setting unit 16 sets the modified traveling route as a target route, automated driving is started along the target route. The automated driving controller 17 controls the automated driving, and properly controls the steering mechanism and the braking and driving mechanism so that the subject vehicle travels according to the position information and the speed information which are associated with the target route. Since the modified traveling route created by the traveling route modifying unit 15 is used as the speed information, the subject vehicle travels in automated mode with the estimated speed limit characteristics or the estimated curved road speed characteristics being reflected.

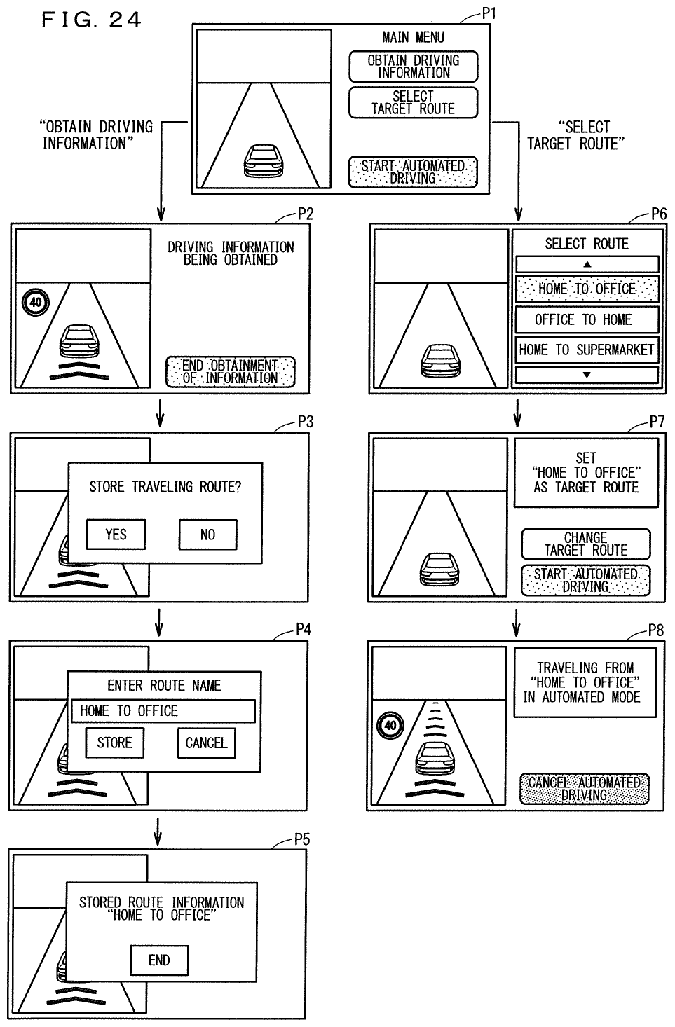

Next, a method for using the automated driving control device 200 will be described using FIG. 24 with reference to FIG. 23. Here, operations performed by the operating apparatus that the user can operate using a touch panel will be described as one example. Although FIG. 24 illustrates display screens P1 to P8 to be displayed on the touch panel according to operations of the user, the display screens are not limited to these but are examples.

The display screen P1 in FIG. 24 is a screen displaying a main menu. Choices of user operations are displayed on the right of the screen, and an illustration representing a state of generating a traveling route is displayed on the left. The user first selects “OBTAIN DRIVING INFORMATION” from the display screen P1 to obtain the driving information.

Once the user selects “OBTAIN DRIVING INFORMATION”, the touch panel is switched to the display screen P2. The automated driving control device 200 is placed in a mode of obtaining the driving information. When the subject vehicle is manually driven by the user in this mode, the driving information obtaining unit 11 obtains the position information. The speed limit information obtaining unit 13 obtains the speed limit information on a road through which the subject vehicle is traveling. On the left of the display screen P2, the path of arrows behind the subject vehicle represents that the driving information is being obtained. In addition, an illustration of a speed limit sign represents information on the speed limit.

After the subject vehicle has been driven to the destination with the driving information being obtained and “END OBTAINMENT OF INFORMATION” on the display screen P2 is selected, the driving information obtaining unit 11 ends obtainment of the driving information. Then, the touch panel is switched to the display screen P3 which displays choices indicating whether the traveling route needs to be stored. If the user selects “YES”, a screen for entering an arbitrary name (route name) for the obtained traveling route is displayed so that the user can identify the details of the traveling route as illustrated in the display screen P4. A method for entering a route name may be a write input using an indicator such as a touch pen or the fingertip, or a touch input using a keyboard displayed on a pop-up screen that is not illustrated.

Once a route name is entered and “STORE” in the display screen P4 is selected, the traveling route generating device 100B is requested to store the traveling route.

Once the user requests storing the traveling route, first, the traveling route creating unit 12 performs a process of creating the traveling route. Next, the estimated speed limit characteristics and the estimated curved road speed characteristics are calculated for the traveling route created by the traveling route creating unit 12, using the speed limit information obtained from the speed limit information obtaining unit 13 and the road curvature information obtained from the road curvature information obtaining unit 14. Then, the traveling route modifying unit 15 automatically modifies the speed information on the traveling route created by the traveling route creating unit 12, based on the calculated estimated speed limit characteristics and estimated curved road speed characteristics to create a modified traveling route. Once the traveling route modifying unit 15 creates the modified traveling route, completion of storing the modified traveling route by the route name “HOME TO OFFICE” is displayed as illustrated in the display screen P5.

After storing the modified traveling route is completed and “SELECT TARGET ROUTE” is selected from the main menu in the display screen P1 on the touch panel, a list of modified traveling routes created in the past is displayed as illustrated in the display screen P6. Once a name of the traveling route requested by the user, for example, “HOME TO OFFICE” is selected, the target route setting unit 16 sets a corresponding one of the modified traveling routes as a target route. Then, setting “HOME TO OFFICE” as the target route is displayed on the touch panel as illustrated in the display screen P7. Then, after “START AUTOMATED DRIVING” in the display screen P7 is selected, a mode for automated driving along the selected target route is put on standby.

Then, the subject vehicle moves through manual driving of the user. When the subject vehicle reaches the selected target route, the automated driving controller 17 starts controlling automated driving of the subject vehicle. Here, a state in which the subject vehicle is traveling in automated mode is displayed on the touch panel as illustrated in the display screen P8. On the left of the display screen P8, the path of arrows behind the subject vehicle represents that the subject vehicle is traveling along the target route. In addition, an illustration of a speed limit sign represents information on the speed limit.

As described above, since the automated driving control device 200 according to Embodiment 4 implements automated driving with the estimated speed limit characteristics or the estimated curved road speed characteristics being reflected, this enables the subject vehicle to travel in automated mode at a traveling speed that the driver considers proper.

Although the display screens P1 to P8 to be displayed on the touch panel in FIG. 24 show an example of displaying the speed limit information using the illustration of the speed limit sign, curvature information on a curved road may be displayed using an illustration.

### Embodiment 5

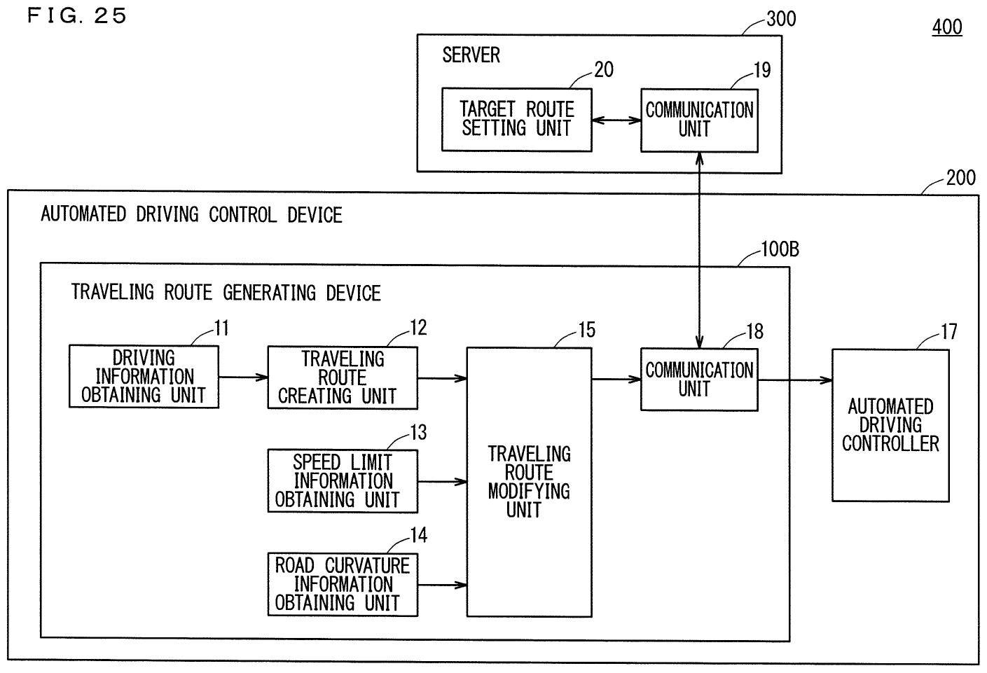

FIG. 25 is a functional block diagram illustrating a configuration of an automated driving control system 400 according to Embodiment 5. As illustrated in FIG. 25, the automated driving control system 400 includes the automated driving control device 200 according to Embodiment 4 in FIG. 23, and a server 300 externally disposed.

The traveling route generating device 100B includes a communication unit 18 that communicates with the server 300 and the automated driving controller 17.

The server 300 includes a communication unit 19 that communicates with the traveling route generating device 100B, and a target route setting unit 20 that sets a target route. The server 300 communicates with the communication unit 18 of the traveling route generating device 100B through the communication unit 19 to transmit and receive information on the traveling route modified by the traveling route modifying unit 15.

The target route setting unit 20 of the server 300 sets the modified traveling route received from the automated driving control device 200 through the communication unit 19 as a target route for automated driving by the automated driving controller 17 of the automated driving control device 200, and feeds the target route to the automated driving controller 17 by communicating with the communication unit 18 of the traveling route generating device 100B through the communication unit 19. The server 300 can obtain and store a plurality of modified traveling routes. Since the operations of the traveling route generating device 100B and the automated driving control device 200 are basically identical to those according to Embodiments 3 and 4, the description will be omitted.

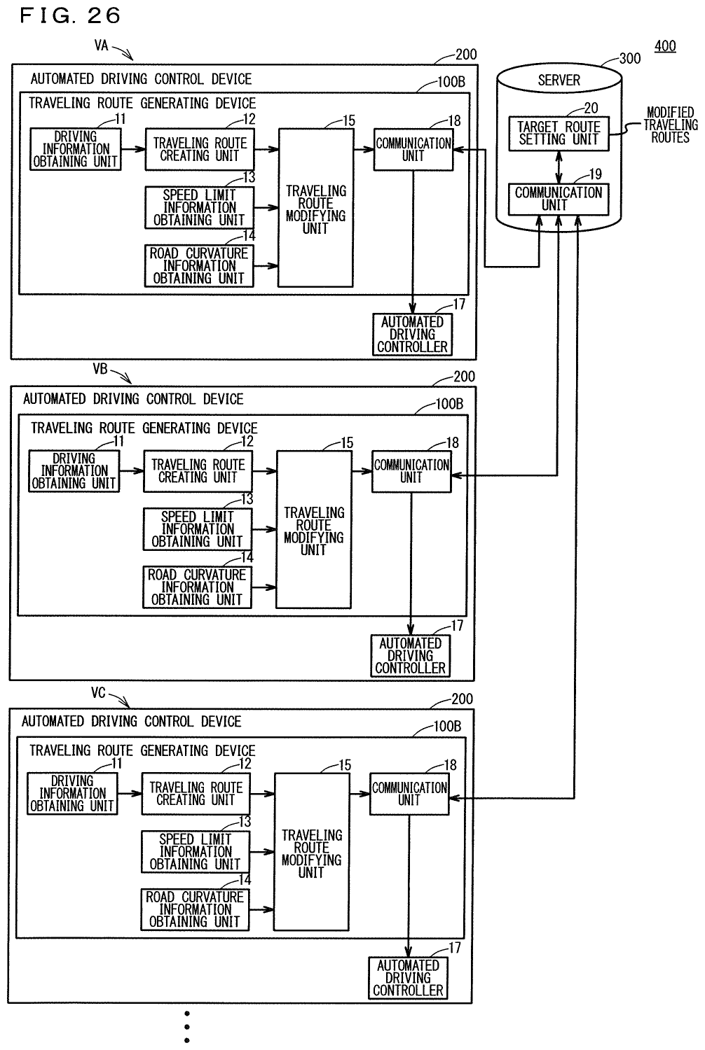

Next, operations of the automated driving control system 400 will be described with reference to FIG. 26. FIG. 26 exemplifies vehicles VA, VB, and VC on each of which the automated driving control device 200 is mounted. All the vehicles can communicate with the server 300 through the respective communication units 18. One of the vehicles VA to VC will be referred to as a “subject vehicle”, and the other vehicles will be referred to as “non-subject vehicles” for convenience.

The modified traveling routes created by the vehicles are transmitted to the server 300, and stored in the target route setting unit 20 of the server 300. Thus, the target route setting unit 20 accumulates a plurality of target route information created by the plurality of vehicles.

The users of the vehicles VA to VC can obtain information on the modified traveling routes accumulated in the server 300, through communicating with the server 300. Here, the information on the modified traveling routes that the user can obtain includes not only the modified traveling route created by the subject vehicle of the user but also the modified traveling routes created by the non-subject vehicles. When the user requests, to the server 300, the modified traveling route through which the user desires to drive the subject vehicle in automated mode, the target route setting unit 20 sets the requested modified traveling route as a target route, and transmits the target route to the subject vehicle of the requesting user. The subject vehicle obtains the modified traveling routes created by not only the subject vehicle but also the non-subject vehicles as the target route information. After obtaining the target route information, the automated driving controller 17 controls the automated driving of the vehicle.

As described above, the information on the modified traveling routes is stored in the server 300 in the automated driving control system 400 according to Embodiment 5. Thus, the traveling route generating device 100B or the automated driving control device 200 to be mounted on the subject vehicle need not include a storage medium for storing the modified traveling routes. Many modified traveling routes can be stored in the server 300. Furthermore, the plurality of vehicles can share the modified traveling routes through the server 300. Even if the subject vehicle has not traveled through a road but at least one of the non-subject vehicles has created the modified traveling route of the road, the modified traveling route can be set as a target route of the subject vehicle. Thus, automated driving of the subject vehicle can be controlled even on a road through which the subject vehicle will travel for the first time.

[Modifications]

Although what is described is that the automated driving control system 400 according to Embodiment 5 is configured to store, in the server 300, the traveling routes modified by the traveling route modifying units 15 of the traveling route generating devices 100B, the automated driving control system 400 may be configured to store traveling routes before modification in the server 300, instead of transmitting the modified traveling routes from the traveling route generating devices 100B.

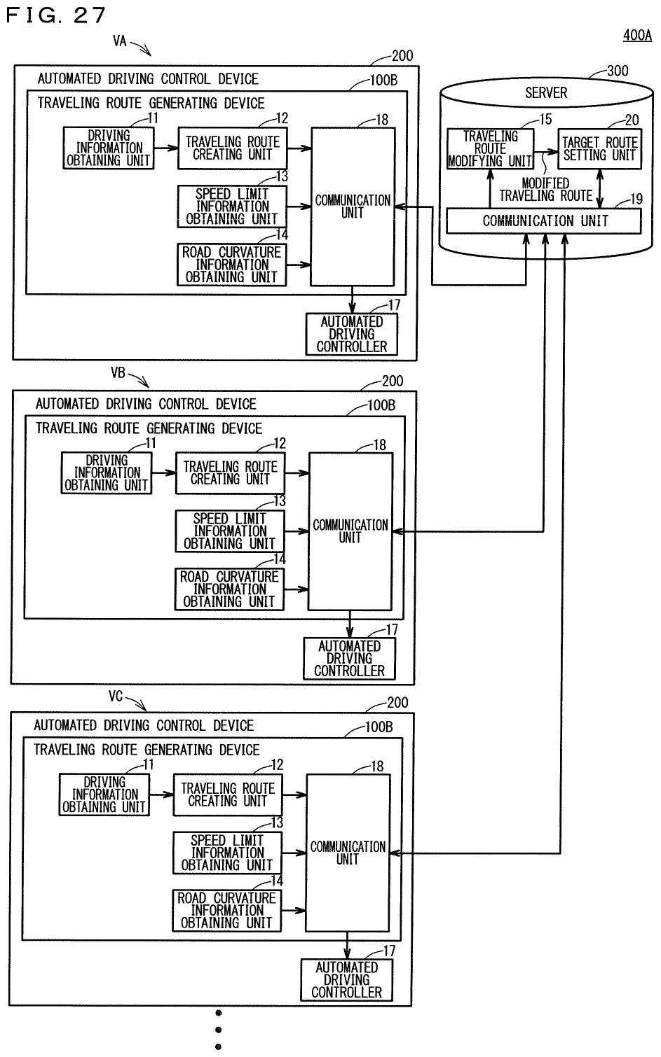

FIG. 27 is a functional block diagram illustrating a configuration of an automated driving control system 400A according to a modification of Embodiment 5. In the automated driving control system 400A, the traveling route generating devices 100B of the vehicles VA to VC do not include the traveling route modifying units 15 as illustrated in FIG. 27. The automated driving control system 400A is configured to transmit the traveling route created by each of the traveling route creating units 12, the speed limit information obtained by each of the speed limit information obtaining units 13, and the road curvature information obtained by each of the road curvature information obtaining units 14, to the communication unit 18 of the server 300 through each of the communication units 18.

The server 300 includes the traveling route modifying unit 15 and the target route setting unit 20, and can receive the traveling route before modification, the speed limit information, and the road curvature information through communicating with each of the traveling route generating devices 100B. The server 300 can calculate the estimated speed limit characteristics and the estimated curved road speed characteristics, based on these received pieces of information. The traveling route modifying unit 15 in the server 300 can create a modified traveling route.

Since the server 300 creates a modified traveling route in the automated driving control system 400A, each of the vehicles need not create the modified traveling route. This reduces the processing load for processing data in the traveling route generating devices 100B.

[Hardware Configuration]

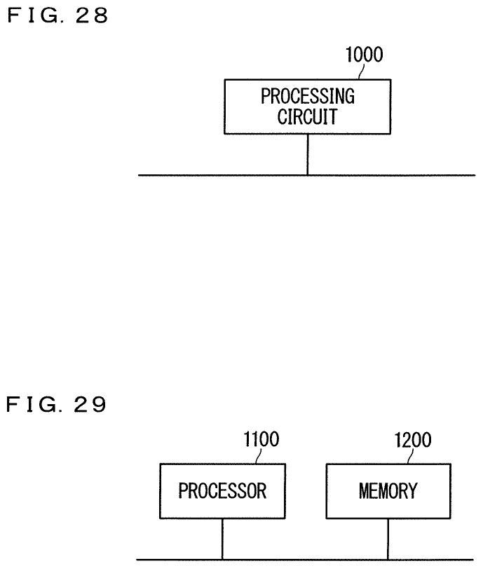

Each of the constituent elements of the traveling route generating devices 100, 100A, and 100B according to Embodiments 1 to 3 can be configured using a computer, and is implemented by causing the computer to execute a program. Specifically, the traveling route generating devices 100 to 100B are implemented by, for example, a processing circuit 1000 illustrated in FIG. 28. A processor such as a central processing unit (CPU) or a digital signal processor (DSP) is applied to the processing circuit 1000. The processing circuit 1000 causes the program stored in a storage device to implement functions of each of the constituent elements.

The processing circuit 1000 may be dedicated hardware. When the processing circuit 1000 is dedicated hardware, it corresponds to, for example, a single circuit, a composite circuit, a programmed processor, a parallel-programmed processor, an application-specific integrated circuit (ASIC), a field-programmable gate array (FPGA), or any combination of these.

FIG. 29 illustrates a hardware configuration when each of the traveling route generating devices 100 to 100B is configured using a processor. Here, the functions of the constituent elements of the traveling route generating devices 100 to 100B are implemented by any combinations with software, etc. (software, firmware, or the software and the firmware). For example, the software is described as a program, and stored in a memory 1200. A processor 1100 that functions as the processing circuit 1000 performs the functions of each of the constituent elements by reading and executing the program stored in the memory 1200 (a storage device). Put it differently, this program causes a computer to execute procedures and methods of operations of the constituent elements of the traveling route generating devices 100 to 100B.

Here, examples of the memory 1200 may include non-volatile or volatile semiconductor memories such as a random access memory (RAM), a read-only memory (ROM), a flash memory, an Erasable Programmable Read Only Memory (EPROM), and an Electrically Erasable Programmable Read-Only Memory (EEPROM), a hard disk drive (HDD), a magnetic disc, a flexible disk, an optical disk, a compact disk, a mini disk, a Digital Versatile Disc (DVD), a drive device thereof, and further any storage medium to be used in the future.

What is described is that, for example, one of hardware and software implements the functions of each of the constituent elements of the traveling route generating devices 100 to 100B. However, the configuration is not limited to this, but a part of the constituent elements of the traveling route generating devices 100 to 100B may be implemented by dedicated hardware, and another part of the constituent elements may be implemented by software, etc. For example, the processing circuit 1000 functioning as the dedicated hardware can implement the functions of the part of the constituent elements, and the processing circuit 1000 functioning as the processor 1100 can implement the functions of the other part of the constituent elements through reading and executing a program stored in the memory 1200.

As described above, the traveling route generating devices 100 to 100B can implement each of the functions by hardware, software, etc., or any combinations of these.

Although this disclosure is described in detail, the description is in all aspects illustrative and does not restrict the disclosure. Numerous modifications and variations that have not yet been exemplified can be devised without departing from the scope of the disclosure.

Embodiments of this disclosure can be freely combined or appropriately modified and omitted within the scope of the disclosure.

1-9. (canceled)

10. A traveling route generating device, comprising:
processing circuitry configured to perform
a driving information obtaining process to obtain position information and speed information on a vehicle with a plurality of timings when a driver manually drives the vehicle;
a traveling route creating process to create a traveling route of the vehicle manually driven, using the position information and the speed information obtained by the driving information obtaining process;
a speed limit information obtaining process to obtain speed limit information on a road through which the vehicle has traveled; and
a traveling route modifying process to modify the speed information on the traveling route based on the speed limit information obtained by the speed limit information obtaining process to generate a modified traveling route.

11. The traveling route generating device according to claim 10,
wherein the processing circuitry, in the traveling route modifying process, estimates speed characteristics of the driver toward speed limits, based on the speed limit information obtained by the speed limit information obtaining process and the speed information on the traveling route created by the traveling route creating process to calculate estimated speed limit characteristics, and
the processing circuitry, in the traveling route modifying process, modifies the speed information on the traveling route to create the modified traveling route, to match the estimated speed limit characteristics in a section in which the speed information on the traveling route does not match the estimated speed limit characteristics.

12. The traveling route generating device according to claim 11,
wherein the processing circuitry, in the traveling route creating process, organizes, into an element, the position information and the speed information obtained with each of the plurality of timings, and arranges a plurality of the elements in chronological order to form the traveling route, and
the processing circuitry, in the traveling route modifying process, obtains, as a speed information mode, a speed whose number of elements in the plurality of the elements is maximum from the speed information on the traveling route in sections whose speed limits are identical, sets plus and minus tolerances of the speed information mode that is a median value, and defines a speed range with a width of the set tolerances as the estimated speed limit characteristics.

13. A traveling route generating device, comprising:
processing circuitry configured to perform
a driving information obtaining process to obtain position information and speed information on a vehicle with a plurality of timings when a driver manually drives the vehicle,
a traveling route creating process to create a traveling route of the vehicle manually driven, using the position information and the speed information obtained by the driving information obtaining process;
a road curvature information obtaining process to obtain curvature information on a road through which the vehicle has traveled; and
a traveling route modifying process to modify the speed information on the traveling route based on the curvature information obtained by the road curvature information obtaining process to generate a modified traveling route.

14. The traveling route generating device according to claim 13,
wherein the processing circuitry, in the traveling route modifying process, estimates speed characteristics of the driver toward curvatures of curved roads, based on the curvature information obtained by the road curvature information obtaining process and the speed information on the traveling route created by the traveling route creating process to calculate estimated curved road speed characteristics, and
the processing circuitry, in the traveling route modifying process, modifies the speed information on the traveling route to create the modified traveling route, to match the estimated curved road speed characteristics in a section in which the speed information on the traveling route does not match the estimated curved road speed characteristics.

15. The traveling route generating device according to claim 14,
wherein the processing circuitry, in the traveling route creating process, organizes, into an element, the position information and the speed information obtained with each of the plurality of timings, and arranges a plurality of the elements in chronological order to form the traveling route, and
the processing circuitry, in the traveling route modifying process, obtains, as a speed information mode, a speed whose number of elements in the plurality of the elements is maximum from the speed information on the traveling route in curved roads whose curvatures are identical, sets plus and minus tolerances of the speed information mode that is a median value, and defines a speed range with a width of the set tolerances as the estimated curved road speed characteristics.

16. A traveling route generating device, comprising:
processing circuitry configured to perform
a driving information obtaining process to obtain position information and speed information on a vehicle with a plurality of timings when a driver manually drives the vehicle;
a traveling route creating process to create a traveling route of the vehicle manually driven, using the position information and the speed information obtained by the driving information obtaining process;
a speed limit information obtaining process to obtain speed limit information on a road through which the vehicle has traveled;
a road curvature information obtaining process to obtain curvature information on the road through which the vehicle has traveled; and
a traveling route modifying process to modify the speed information on the traveling route based on the speed limit information obtained by the speed limit information obtaining process and the curvature information obtained by the road curvature information obtaining process to generate a modified traveling route.

17. The traveling route generating device according to claim 16,
wherein the processing circuitry, in the traveling route modifying process, estimates speed characteristics of the driver toward speed limits, based on the speed limit information obtained by the speed limit information obtaining process and the speed information on the traveling route created by the traveling route creating process to calculate estimated speed limit characteristics, and
the processing circuitry, in the traveling route modifying process, modifies the speed information on the traveling route to create the modified traveling route, to match the estimated speed limit characteristics in a section in which the speed information on the traveling route does not match the estimated speed limit characteristics.

18. The traveling route generating device according to claim 17,
wherein the processing circuitry, in the traveling route creating process, organizes, into an element, the position information and the speed information obtained with each of the plurality of timings, and arranges a plurality of the elements in chronological order to form the traveling route, and
the processing circuitry, in the traveling route modifying process, obtains, as a speed information mode, a speed whose number of elements in the plurality of the elements is maximum from the speed information on the traveling route in sections whose speed limits are identical, sets plus and minus tolerances of the speed information mode that is a median value, and defines a speed range with a width of the set tolerances as the estimated speed limit characteristics.

19. The traveling route generating device according to claim 16,
wherein the processing circuitry, in the traveling route modifying process, estimates speed characteristics of the driver toward curvatures of curved roads, based on the curvature information obtained by the road curvature information obtaining process and the speed information on the traveling route created by the traveling route creating process to calculate estimated curved road speed characteristics, and
the processing circuitry, in the traveling route modifying process, modifies the speed information on the traveling route to create the modified traveling route, to match the estimated curved road speed characteristics in a section in which the speed information on the traveling route does not match the estimated curved road speed characteristics.

20. The traveling route generating device according to claim 19,
wherein the processing circuitry, in the traveling route creating process, organizes, into an element, the position information and the speed information obtained with each of the plurality of timings, and arranges a plurality of the elements in chronological order to form the traveling route, and
the processing circuitry, in the traveling route modifying process, obtains, as a speed information mode, a speed whose number of elements in the plurality of the elements is maximum from the speed information on the traveling route in curved roads whose curvatures are identical, sets plus and minus tolerances of the speed information mode that is a median value, and defines a speed range with a width of the set tolerances as the estimated curved road speed characteristics.

21. An automated driving control device, comprising:
the traveling route generating device according to claim 10; and
processing circuitry configured to perform
a target route setting process to set the modified traveling route created by the traveling route generating device as a target route for automated driving of the vehicle; and
an automated driving control process to control automated driving of the vehicle according to position information and speed information on the target route set by the target route setting process.

22. An automated driving control device, comprising:
the traveling route generating device according to claim 13; and
processing circuitry configured to perform a target route setting process to set the modified traveling route created by the traveling route generating device as a target route for automated driving of the vehicle; and
an automated driving control process to control automated driving of the vehicle according to position information and speed information on the target route set by the target route setting process.

23. An automated driving control device, comprising:
the traveling route generating device according to claim 16; and
processing circuitry configured to perform
a target route setting process to set the modified traveling route created by the traveling route generating device as a target route for automated driving of the vehicle; and
an automated driving control process to control automated driving of the vehicle according to position information and speed information on the target route set by the target route setting process.

24. An automated driving control system, comprising:
the traveling route generating device according to claim 10;
an automated driving control device to control automated driving of the vehicle; and
a server to communicate with the automated driving control device, the server being disposed outside the vehicle,
wherein the automated driving control device transmits, to the server, the modified traveling route created by the traveling route modifying process of the traveling route generating device,
the server sets the modified traveling route transmitted from the traveling route generating device as a target route for automated driving of the vehicle,
the server transmits the target route to the automated driving control device, and
the automated driving control device controls automated driving of the vehicle according to position information and speed information on the target route transmitted from the server.

25. An automated driving control system, comprising:
the traveling route generating device according to claim 13;
an automated driving control device to control automated driving of the vehicle; and
a server to communicate with the automated driving control device, the server being disposed outside the vehicle,
wherein the automated driving control device transmits, to the server, the modified traveling route created by the traveling route modifying process of the traveling route generating device,
the server sets the modified traveling route transmitted from the traveling route generating device as a target route for automated driving of the vehicle,
the server transmits the target route to the automated driving control device, and
the automated driving control device controls automated driving of the vehicle according to position information and speed information on the target route transmitted from the server.

26. An automated driving control system, comprising:
the traveling route generating device according to claim 16;
an automated driving control device to control automated driving of the vehicle; and
a server to communicate with the automated driving control device, the server being disposed outside the vehicle,
wherein the automated driving control device transmits, to the server, the modified traveling route created by the traveling route modifying process of the traveling route generating device,
the server sets the modified traveling route transmitted from the traveling route generating device as a target route for automated driving of the vehicle,
the server transmits the target route to the automated driving control device, and
the automated driving control device controls automated driving of the vehicle according to position information and speed information on the target route transmitted from the server.
